(19) United States
(12) Patent Application Publication
(10) Pub. No.: US 2017/0116410 A1
(43) Pub. Date: Apr. 27, 2017

(54) SOFTWARE PROTECTION

(71) Applicant: IRDETO B.V., Hoofddorp (NL)

(72) Inventors: Andrew Wajs, Hoofddorp (NL); Harold Johnson, Hoofddorp (NL); Yuan Gu, Hoofddorp (NL); Wim Mooij, Hoofddorp (NL); Hans Dekker, Hoofddorp (NL); Calin Ciordas, Hoofddorp (NL); Fan Zhang, Hoofddorp (NL)

(73) Assignee: IRDETO B.V., Hoofddorp (NL)

(21) Appl. No.: 15/300,572

(22) PCT Filed: Mar. 31, 2015
(86) PCT No.: PCT/EP2015/057044

§ 371 Date: Sep. 29, 2016

(30) Foreign Application Priority Data
Mar. 31, 2014 (GB) 1405706.1

(51) Int. Cl. G06F 21/53; G06F 9/44; G06F 21/60; G06F 21/54

(52) U.S. Cl. CPC G06F 21/53; G06F 21/54; G06F 8/70; G06F 21/602

(57) ABSTRACT

A method comprising: providing a protected item of software to a device, wherein the protected item of software is in a scripted language or an interpreted language or source code, wherein the protected item of software, when executed by the device, is arranged to perform a security-related operation for the device, wherein the security-related operation is implemented, at least in part, by at least one protected portion of code in the protected item of software, wherein the at least one protected portion of code is arranged so that (a) the at least one protected portion of code has resistance against a white-box attack and/or (b) the at least one protected portion of code may only be executed on one or more predetermined devices.

### FIELD OF THE INVENTION

The present invention relates to methods of providing and executing protected items of software, apparatus and computer programs for carrying out such methods, and protected items of software themselves.

### BACKGROUND OF THE INVENTION

Web computing is entering an exciting stage with Open Web Platform while a set of open standards (such as HTML5, SVG, CSS, JavaScript and others) are advancing together so that programmes that once worked only in a native environment of a device (such as a desktop computer, a tablet computer, a mobile telephone, etc.) can now work from within a browser executing on any such device. Such standards enable web apps to have all the power of HTML5, like easily-inserted video and easily-inserted conferences. Similarly, such standards provide APIs for allowing web apps to access hardware and other capabilities on the device (such as local storage, a GPU, an accelerometer, a camera, etc.). Web apps can work on any platform where a browser is installed, no matter whether the platform is a managed or an unmanaged device that contains open or close subsystems. In contrast, native apps that work on a single platform or even a single device are more limited than web apps. With web apps, a web page can become a programmable computing environment, regardless of the device executing the browser that processes the web page. As tablets are replacing laptops, and smartphones are replacing wired lines and fixed function devices, mobile apps now not only impact consumers' personal life but also represent core productivity tools of the modern workforce. Open Web standards also provide support to allow web apps to connect their computing activities between client devices and web-based services in cloud environments. Therefore, using web apps, people can easily access any content from anywhere at any time by using available devices and at their own convenience.

Meanwhile, today's threats through the web and mobile spaces are rapidly evolving from typically unsophisticated attackers and organized crimes to much more advanced actors with advanced attacks. Almost everything, including emails and personal data, can become a target for an attack. Invariably, security breaches lead to data compromise within “days” or less, whereas usually security breaches take “weeks” or more to discover. This presents a significant challenge to security technology and response teams as it grants attackers extended periods of time within a victim's environment. More “time” spent for deploying a countermeasure leads to more stolen data and more digital damage.

Simultaneously, threats are becoming exponentially more sophisticated and advanced. The threats often seen today are agile and dynamic, more focused for very specific goals and a narrow class of organizations and groups if necessary, more intelligent and smarter that uses a wide range of social engineering techniques and technical exploits to gain a foothold within victims and avoid detection. Some security threats and security breaches are so serious that an appropriate response requires an update to a widely used interface and/or protocol. As this implies a very long transition process, the attack life cycle can be extremely long.

Web apps are often written in a scripted (or interpreted) language, such as JavaScript (although other scripted languages, such as PHP and Python, are often used). With such scripted or interpreted languages, a webserver sends source code of the web app to a browser of the target/recipient device. The user of the device can then view, monitor and modify execution of the source code (either during interpretation or after just-in-time compilation within the browser). This makes it very easy for an attacker to copy and modify the source code and use it in another webserver or on another device. The use of such scripted or interpreted languages make the effort needed by the attacker to successfully launch an attack significantly less than if the attacker had simply been provided with an compiled executable or binary file.

A “white-box” environment is an execution environment for an item of software in which an attacker of the item of software is assumed to have full access to, and visibility of, the data being operated on (including intermediate values), memory contents and execution/process flow of the item of software. Moreover, in the white-box environment, the attacker is assumed to be able to modify the data being operated on, the memory contents and the execution/process flow of the item of software, for example by using a debugger—in this way, the attacker can experiment on, and try to manipulate the operation of, the item of software, with the aim of circumventing initially intended functionality and/or identifying secret information and/or for other purposes. Indeed, one may even assume that the attacker is aware of the underlying algorithm being performed by the item of software. However, the item of software may need to use secret information (e.g. one or more cryptographic keys), where this information needs to remain hidden from the attacker. Similarly, it would be desirable to prevent the attacker from modifying the execution/control flow of the item of software, for example preventing the attacker forcing the item of software to take one execution path after a decision block instead of a legitimate execution path. Given the nature of scripted or interpreted languages, an item of software, such as a web app, written in such a scripted or interpreted language will inherently execute in a white-box environment.

Existing techniques for protecting JavaScript code are relatively weak. For example, some techniques simply replace instances of variable names or function names that are meaningful to a human reader with obfuscated (e.g. random) variable names or function names. This does not, however, hide the actual functionality or data from an attacker. Similarly, some techniques encrypt a portion of the JavaScript code, with the encrypted portion being decrypted at runtime—however, the encrypted portion of code is decrypted at runtime and so is still observable by the attacker. With existing techniques, it is easy for an attacker to re-distribute an item of software to other devices, so that those other devices can make use of that item of software, perhaps in an unauthorised manner.

### SUMMARY OF THE INVENTION

Given the increased use of web apps and the increasing move away from using native applications, it would be desirable to be able to provide improved security for such web apps. However, given that such web apps are often implemented using a scripted or interpreted language, such as JavaScript, such web apps are intrinsically easier for an attacker to analyse, since the attacker has access to the initial source code.

According to a first aspect of the invention, there is provided a method comprising: providing a protected item of software to a device, wherein the protected item of software is in a scripted language or an interpreted language or source code, wherein the protected item of software, when executed by the device, is arranged to perform a security-related operation for the device, wherein the security-related operation is implemented, at least in part, by at least one protected portion of code in the protected item of software, wherein the at least one protected portion of code is arranged so that (a) the at least one protected portion of code has resistance against a white-box attack and/or (b) the at least one protected portion of code may only be executed on one or more predetermined devices.

In some embodiments, the method comprises: obtaining an initial item of software, wherein the security-related operation is implemented, at least in part, by at least one initial portion of code in the initial item of software; generating the protected item of software, said generating comprising modifying at least the at least one initial portion of code to form the at least one protected portion of code. Said modifying may comprise applying one or more white-box protection techniques to the at least one initial portion of code. Additionally or alternatively, said modifying may comprise applying one or more node-locking techniques to the at least one initial portion of code.

According to a second aspect of the invention, there is provided a method comprising: obtaining at a device a protected item of software, wherein the protected item of software is in a scripted language or an interpreted language or source code, wherein the protected item of software, when executed by the device, is arranged to perform a security-related operation for the device, wherein the security-related operation is implemented, at least in part, by at least one protected portion of code in the protected item of software, wherein the at least one protected portion of code is arranged so that (a) the at least one protected portion of code has resistance against a white-box attack and/or (b) the at least one protected portion of code may only be executed on one or more predetermined devices; and executing, on the device, the at least one protected portion of code of the obtained protected item of software.

In embodiments of either of the above aspects of the invention, the security-related operation may use secret data and the at least one protected portion of code may then be in an obfuscated form to thereby protect the secret data against the white-box attack.

In embodiments of either of the above aspects of the invention, the security-related operation may comprise one or more of: (i) a cryptographic operation; (ii) a conditional access operation; (iii) a digital rights management operation; (iv) concealing the destination of a communication; (v) a key management operation; (vi) a communication operation to establish a link to a server without using a lower level security sensitive primitive. The cryptographic operation may comprise one or more of: an encryption operation; a decryption operation; a digital signature generation operation; a digital signature verification operation.

In embodiments of either of the above aspects of the invention, the language may be one or more of: (i) JavaScript; (ii) PHP; (iii) Python; (iv) asm.js; (v) Ruby.

In embodiments of either of the above aspects of the invention, the protected item of software may be for execution in a browser on the device.

In embodiments of either of the above aspects of the invention, the protected item of software may be a web app.

According to a third aspect of the invention, there is provided an apparatus arranged to carry out any one of the above methods.

According to a fourth aspect of the invention, there is provided a computer program which, when executed by a processor, causes the processor to carry out any one of the above methods. The computer program may be stored on a computer-readable medium.

According to a fifth aspect of the invention, there is provided a protected item of software for execution by a device, wherein the protected item of software is in a scripted language or an interpreted language or source code, when executed by the device, is arranged to perform a security-related operation for the device, wherein the security-related operation is implemented, at least in part, by at least one protected portion of code in the protected item of software, wherein the at least one protected portion of code is arranged so that (a) the at least one protected portion of code has resistance against a white-box attack and/or (b) the at least one protected portion of code may only be executed on one or more predetermined devices.

In some embodiments, the security-related operation uses secret data and wherein the at least one protected portion of code is in an obfuscated form to thereby protect the secret data against the white-box attack.

In some embodiments, the security-related operation comprises one or more of: (i) a cryptographic operation; (ii) a conditional access operation; (iii) a digital rights management operation; (iv) concealing the destination of a communication; (v) a key management operation; (vi) a communication operation to establish a link to a server without using a lower level security sensitive primitive. The cryptographic operation may comprise one or more of: an encryption operation; a decryption operation; a digital signature generation operation; a digital signature verification operation.

In some embodiments, the language is one or more of: (i) JavaScript; (ii) PHP; (iii) Python; (iv) asm.js; (v) Ruby.

In some embodiments, the protected item of software is for execution in a browser on the device.

In some embodiments, the protected item of software is a web app.

### BRIEF DESCRIPTION OF THE DRAWINGS

Embodiments of the invention will now be described, by way of example only, with reference to the accompanying drawings, in which:

FIG. 1 schematically illustrates an example of a computer system;

FIG. 2 schematically illustrates an example system according to an embodiment of the invention;

FIG. 3 schematically illustrates an example architecture for the client device;

FIG. 4 is a flow chart schematically illustrating a method according to an embodiment of the invention;

FIG. 5 schematically illustrates components (or modules or applications) executed by a server to help implement embodiments of the invention;

FIG. 6 schematically illustrates a protection tool according to an embodiment of the invention;

FIG. 7 schematically illustrates an example of a computer system including an optimization and protection toolset A40,

FIG. 8 illustrates in more detail an example of the optimization and protection toolset A40 of FIG. 7;

FIG. 9 provides a flow diagram of a method example;

FIG. 10 illustrates a work flow which can be implemented by the optimization and protection toolset A40 of FIG. 8;

FIG. 11 illustrates a work flow similar to that of FIG. 10 but within which an input item of software in a source code representation is converted to LLVM IR using LLVM front end tools;

FIG. 12 is similar to FIG. 11 but with an input item of software in a binary or native code representation;

FIG. 13 illustrates a work flow similar to that of FIGS. 10 to 12 but within which LLVM compiler middle layer tools are used to implement binary rewriting protection of the item of software in the first intermediate representation;

FIG. 14 shows a work flow which may be implemented using the optimization and protection toolset of FIG. 8, in which the output representation is an asm.js or other executable script representation;

FIG. 15 shows schematically the optimization and protection toolset of FIG. 8 with some further variations and details;

FIG. 16 shows how the arrangement of FIG. 8 can be expanded to use a larger number of intermediate representations, and to apply optimization and/or protection in different ones of these intermediate representations; and

FIG. 17 illustrates the processing of software items such as security libraries, modules and agents by the optimization and protection toolset.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

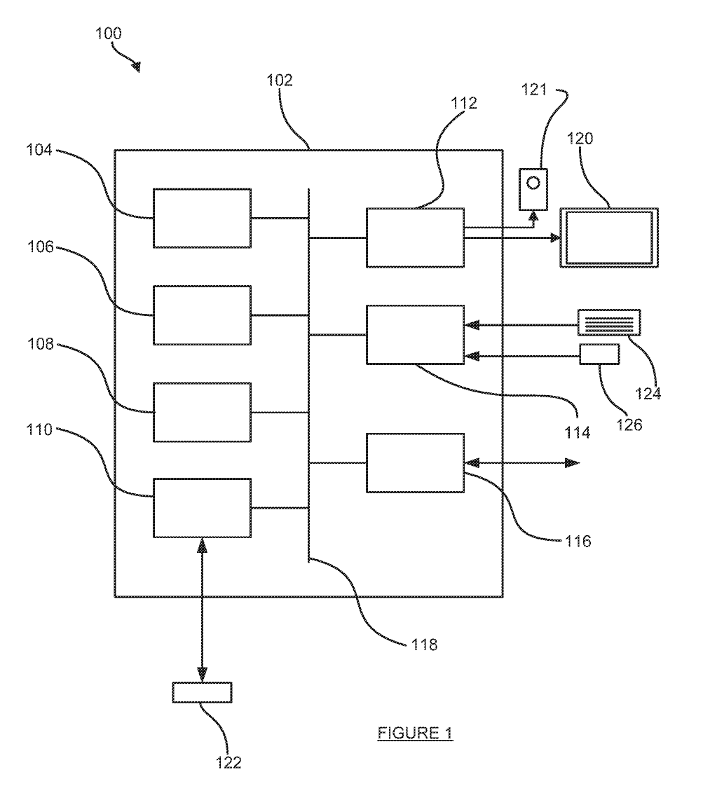

FIG. 1 schematically illustrates an example of a computer system 100. The system 100 comprises a computer 102. The computer 102 comprises: a storage medium 104, a memory 106, a processor 108, an interface 110, a user output interface 112, a user input interface 114 and a network interface 116, which are all linked together over one or more communication buses 118.

The storage medium 104 may be any form of non-volatile data storage device such as one or more of a hard disk drive, a magnetic disc, an optical disc, a ROM, etc. The storage medium 104 may store an operating system for the processor 108 to execute in order for the computer 102 to function. The storage medium 104 may also store one or more computer programs (or software or instructions or code).

The memory 106 may be any random access memory (storage unit or volatile storage medium) suitable for storing data and/or computer programs (or software or instructions or code).

The processor 108 may be any data processing unit suitable for executing one or more computer programs (such as those stored on the storage medium 104 and/or in the memory 106), some of which may be computer programs according to embodiments of the invention or computer programs that, when executed by the processor 108, cause the processor 108 to carry out a method according to an embodiment of the invention and configure the system 100 to be a system according to an embodiment of the invention. The processor 108 may comprise a single data processing unit or multiple data processing units operating in parallel or in cooperation with each other. The processor 108, in carrying out data processing operations for embodiments of the invention, may store data to and/or read data from the storage medium 104 and/or the memory 106.

The interface 110 may be any unit for providing an interface to a device 122 external to, or removable from, the computer 102. The device 122 may be a data storage device, for example, one or more of an optical disc, a magnetic disc, a solid-state-storage device, etc. The device 122 may have processing capabilities—for example, the device may be a smart card. The interface 110 may therefore access data from, or provide data to, or interface with, the device 122 in accordance with one or more commands that it receives from the processor 108.

The user input interface 114 is arranged to receive input from a user, or operator, of the system 100. The user may provide this input via one or more input devices of the system 100, such as a mouse (or other pointing device) 126 and/or a keyboard 124, that are connected to, or in communication with, the user input interface 114. However, it will be appreciated that the user may provide input to the computer 102 via one or more additional or alternative input devices (such as a touch screen). The computer 102 may store the input received from the input devices via the user input interface 114 in the memory 106 for the processor 108 to subsequently access and process, or may pass it straight to the processor 108, so that the processor 108 can respond to the user input accordingly.

The user output interface 112 is arranged to provide a graphical/visual and/or audio output to a user, or operator, of the system 100. As such, the processor 108 may be arranged to instruct the user output interface 112 to form an image/video signal representing a desired graphical output, and to provide this signal to a monitor (or screen or display unit) 120 of the system 100 that is connected to the user output interface 112. Additionally or alternatively, the processor 108 may be arranged to instruct the user output interface 112 to form an audio signal representing a desired audio output, and to provide this signal to one or more speakers 121 of the system 100 that is connected to the user output interface 112.

Finally, the network interface 116 provides functionality for the computer 102 to download data from and/or upload data to one or more data communication networks.

It will be appreciated that the architecture of the system 100 illustrated in FIG. 1 and described above is merely exemplary and that other computer systems 100 with different architectures (for example with fewer components than shown in FIG. 1 or with additional and/or alternative components than shown in FIG. 1) may be used in embodiments of the invention. As examples, the computer system 100 could comprise one or more of: a personal computer; a server computer; a mobile telephone; a tablet; a laptop; a television set; a set top box; a games console; other mobile devices or consumer electronics devices; etc.

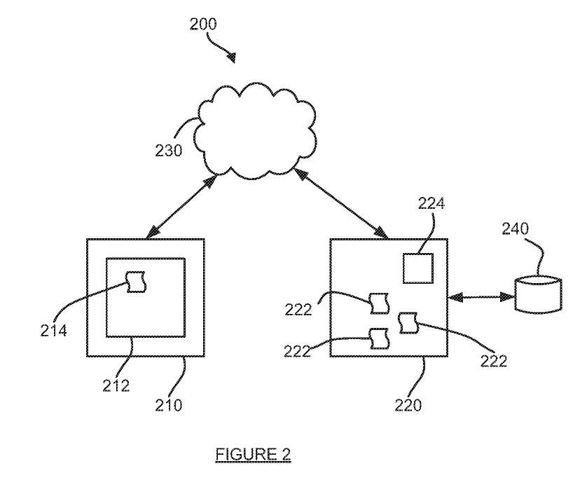

FIG. 2 schematically illustrates an example system 200 according to an embodiment of the invention. The system 200 comprises a client device 210, a server 220 and a network 230. The system 200 may, optionally, comprise a database, or a data repository or a data source, 240.

The network 230 may be any kind of data communication network suitable for communicating or transferring data between the client device 210 and the server 220. Thus, the network 230 may comprise one or more of: a local area network, a wide area network, a metropolitan area network, the Internet, a wireless communication network, a wired or cable communication network, a satellite communications network, a telephone network, etc. The client device 210 and the server 220 may be arranged to communicate with each other via the network 230 via any suitable data communication protocol. For example, when the network 230 is the Internet, the data communication protocol may be HTTP.

The client device 210 may be a computer system, such as the exemplary computer system 100 shown in FIG. 1. For example, the device 210 may be a personal computer, a laptop, a tablet computer, a mobile telephone, etc. The device 210 comprises a browser 212 (or is arranged to execute a browser 212, for example on a processor of the device 210). Browsers 212 are well-known and shall not be described in detail herein—any browser 212 may be used by the device 210. The client device 210 is arranged to receive an item of software 214 from the server 220 via the network 230. The item of software 214 shall be described in more detail shortly. However, in general, the item of software 214 is software or a computer program (i.e. instructions and/or code) that is arranged to run in a web browser (such as the browser 212) and/or is created in a browser-supported programming language. For example, the item of software 214 may be a web app (or at least a part of a web app) that executes within the browser 212. The item of software 214 may form a part of a larger software application, where some of the software application (including the item of software 214) is arranged to execute in the browser 212, whilst another part of the software application does not execute in the browser 212.

The server 220 may be a computer system, such as the exemplary computer system 100 shown in FIG. 1. The server 220 may be arranged to execute or run (for example, on a processor of the server 220) one or more scripts 222 to generate content to be provided to the client device 210. This may include, for example, the server 220 executing one or more scripts 222 to generate the whole or a part of the item of software 214. Additionally, or alternatively, the server 220 may comprise (or be arranged to execute, for example on processor of the server 220) a software protection application 224 that generates the whole or a part of the item of software 214.

The server 220 may be coupled to, or in communication with, the data source 240. The data source may comprise various data, such as web content, that the server 220 may access, or obtain, in order to facilitate the generation (in whole or in part) of the item of software 214.

The server 220 may, itself, have obtained one or more of the scripts 222 and/or the software protection application 224 from another source, such as a further server (not shown in FIG. 2) with which the server 220 is in communication via the network 230. In this sense, then, the server 220 may be considered to be a client device of the further server, with the one or more of the scripts 222 and/or the software protection application 224 that the server 220 obtains from the further server being analogous to the item of software 214 that the client device 210 receives from the server 220.

Current network communications (such as communication via the Internet) are usually based on a set of standards and protocols using the well-known layered approach in which lower layers provide functionality to higher levels. For example, the browser 212 may communicate with the server 220 using the Hyper Text Transfer Protocol (HTTP). Web content communicated between the browser 212 and the server 220 may be encoded using the HyperText Markup Language (HTML) which may, for example, be HTML5. A script 222 running in the server 220 may generate web content, with the script running, for example, on top of a LAMP software stack (as is well known in this field of technology, but see http://en.wikipedia.org/wiki/LAMP_(software_bundle), the entire disclosure of which is incorporated herein by reference, for more information on LAMP).

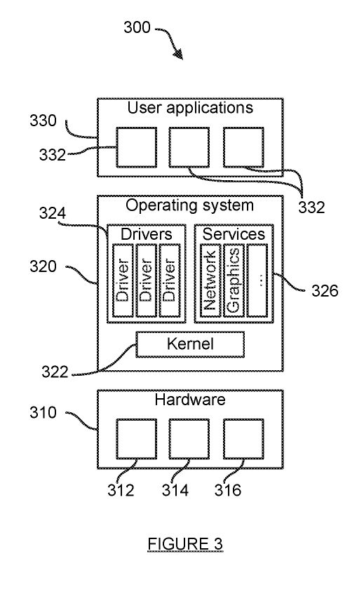

End-user applications running on the client device 210, such as the browser 212, may execute on the client device 210 (or a processor of the client device 210) using a wide range of software stacks forming a layered structure. As is known, security is often implemented at each of these layers. FIG. 3 schematically illustrates an example architecture 300 for the client device 210, as described below.

The architecture 300 comprises a hardware layer 310. In FIG. 3, the hardware layer 310 comprises: (a) a central processing unit (CPU) 312, corresponding, for example, to the processor 108 of the computer system 100 of FIG. 1; (b) a memory 314, corresponding, for example, to one or both of the storage medium 104 and memory 106 of the computer system 100 of FIG. 1; and (c) one or more devices 316, corresponding, for example, to one or more of the interface 110, the user output interface 112, the user input interface 114, the network interface 116, the monitor 120, the one or more speakers 121, the mouse (or other pointing device) 126, and the keyboard 124 of the computer system 100 of FIG. 1. The hardware layer 310 is the layer that actually performs operations and processing.

The architecture 300 also comprises, as the next layer above the hardware layer 310, an operating system 320 for managing the hardware layer 310. As shown in FIG. 3, the operating system 320 may comprise a kernel 322, one or more device drivers 324 for interfacing with and controlling one or more of the devices 316, and one or more services 326 for providing other functionality, such as network control and graphics processing/output.

The architecture 300 also comprises a user application layer 330. The operating system 320 provides an abstract access model of the hardware resources of the hardware layer 310 to the user application layer 330. The user application layer comprises one or more software applications 332 that run on the operating system 320 and that are executed (by the CPU 312). The software applications 332 may perform or provide a user of the client device 210 with any corresponding functionality, such as providing spreadsheets, word processing, or a web browser (such as the web browser 212 of FIG. 2).

The system 200 may be attacked by an attacker at numerous points. For example, network communications (particularly Internet communications) are open to a wide range of attacks: data traffic over the network 230 can be partially blocked, intercepted and/or altered, sometimes without the sender and/or recipient of that data being aware of the blockage, interception or alterations. The client device 210 may be an untrusted computer (i.e. a computer that may, conceivably, be operated by an attacker or open to attack by an attacker)—thus, the browser 212 may execute on an untrusted computer. Similarly, the server 220 may be an untrusted computer—thus the scripts 222 and/or the software protection application 224 may execute on an untrusted computer. Embodiments of the invention address these issues, as will become apparent from the discussion below.

In particular, embodiments of the invention make use of, or implement, one or more protected items of software, as discussed below. For example, the item of software 214 may be (or may comprise) a protected item of software. Similarly, one or more of the scripts 222 may be (or may comprises) a protected item of software. Preferably, both the item of software 214 and the one or more scripts 222 are protected items of software. The term “protected item of software” as used herein is an item of software as follows:
The protected item of software is in a scripted language or an interpreted language or source code, such as JavaScript, PHP, Python, asm.js and Ruby (although it will be appreciated that embodiments of the invention apply equally to other scripted or interpreted programming languages), i.e. they are not items of software that have been compiled into machine-language instructions. The language may be one that is suited for a particular type of client device and/or suited for servers.
The protected item of software, when executed by a device, is arranged to perform a security-related operation for the device. Here, if the protected item of software is the item of software 214, then the “device” is the client device 210; if the protected item of software is one of the scripts 222, then the “device” is the server 220. The term “executed” as used herein in relation to protected items of software shall, given the language/code format mentioned above, be taken to mean run or interpreted (e.g. by an interpreter) or performance of just-in-time compilation by the device.
This security-related operation is implemented, at least in part, by at least one protected portion of code in the protected item of software. This at least one protected portion of code is arranged so that (a) the at least one protected portion of code has resistance against a white-box attack and/or (b) the at least one protected portion of code may only be executed on one or more predetermined devices.

The protected item of software may comprise one or more modules or software components or computer programs, which may be presented or stored within one or more files. Indeed, the protected item of software may be an entire software application, a software library, or the whole or a part of one or more software functions or procedures, or anywhere in-between (as will be appreciated by the person skilled in the art).

As mentioned above, the protected item of software, when executed by a device, is arranged to perform a security-related operation for the device. Thus, the protected item of software may comprise one or more modules or components that provide or implement the security-related operation (or functionality or processing). The security-related operation may use secret data, such as one or more cryptographic keys. The security-related operation may comprise one or more of: (i) a cryptographic operation (which could comprise, for example, one or more of an encryption operation, a decryption operation, a digital signature generation operation, and a digital signature verification operation); (ii) a conditional access operation; (iii) a digital rights management operation; (iv) concealing (or making anonymous, or making it hard for an attacker to determine) the destination of a communication; (v) a (cryptographic) key management operation; (vi) a communication operation to establish a link to a server without using a lower level security sensitive primitive. Such security-related operations are well-known and shall, therefore, not be described in more detail herein. However, usually such security-related operations are performed by lower layers in the architecture 300. Thus, embodiments of the invention may treat existing communication infrastructures as a lower layer of the OSI model that defines unreliable or insecure data delivery—such embodiments therefore help ensure security by implementing their own security-related operations within themselves.

The security-related operation is implemented, at least in part, by at least one portion of code in the protected item of software. The at least one portion of code may comprise one or more fragments of code/instructions and/or one or more amounts of data (such as a look-up table or constant values).

As mentioned, the protected item of software is in a scripted programming language or an interpreted programming language or is in source code. Consequently, as discussed above, the protected item of software, when executed by a device, will be executing in a white-box environment. Therefore, in some embodiments of the invention, the at least one portion of code in the protected item of software is “protected” in the sense that it is arranged, or implemented, so that it has resistance against a white-box attack. Methods for achieving this are discussed later.

Similarly, it may be desirable for the protected item of software to be tied, or locked, to one or more specific devices. In this way, the protected item of software may only be executed on those one or more specific devices, thereby making it more difficult for an attacker to successful perform illicit distribution of the protected item of software. Consequently, in some embodiments of the invention, the at least one portion of code in the protected item of software is “protected” in the sense that it is arranged, or implemented, so that it may only be executed on one or more predetermined devices.

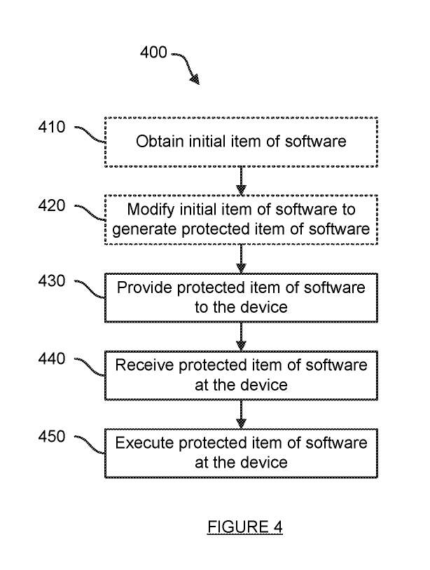

FIG. 4 is a flow chart schematically illustrating a method 400 according to an embodiment of the invention.

At an optional step 410, the server 220 receives or obtains an initial item of software. The initial item of software may be received or obtained, for example, from one or more or more software developers, one or more other servers accessible via the network 230, or any other source. Alternatively, the server 220 may already be storing the initial item of software and may, therefore, access or retrieve the stored initial item of software.

At an optional step 420, the server 220 uses the software protection application 224 and/or one or more of the scripts 222 to apply one or more software protection techniques to the initial item of software to thereby generate the protected item of software. This shall be described in more detail later.

As mentioned, the steps 410 and 420 are optional, because the server 220 may already be storing, or may already have access to, the protected item of software. For example, the server 220 may have previously been provided with, or have previously obtained, the protected item of software instead of having been provided with, or having obtained, the initial item of software to which one or more software protection are then applied. Alternatively, the server 220 may have previously carried out the steps 410 and 420 and may, then, have stored the protected item of software for subsequent use or distribution. In this case, the steps 410 and 420 need not be repeated and the server 220 can simply access or obtain the stored protected item of software.

At a step 430, the server 220 provides the protected item of software to the client device 210. The protected item of software, therefore, corresponds to the item of software 214 illustrated in FIG. 2.

At a step 440, the client device 210 receives the protected item of software.

At a step 450, the client device 210 executes the received protected item of software. This may involve the client device 210 executing the browser 212, with the protected item of software then executing within the browser 212 (e.g. as a web app).

The server 220 may be arranged to perform the step 430 in response to receiving a request from the client device 210 for an item of software. For example, a user of the client device 210 may have used the browser 212 to request a webpage (specified by a URL or a URI) from a server (which may be the server 220), in which case a webpage to be returned to the browser 212 may contain the protected item of software.

The server 220 may be arranged to perform the step 420 of generating the protected item of software from the initial item of software (and therefore possibly also the step 410 of obtaining the initial item of software) in response to receiving the request from the client device 210. In this way, the software protection techniques applied to the initial item of software to generate the protected item of software may be kept up-to-date and may be configured specifically for the requesting client device 210 (e.g. to lock the protected item of software to that client device 210 so that the protected item of software is only executable on that specific client device 210).

As mentioned above, the scripts 222 executed by the server 220 may themselves be protected items of software. Thus, the method 400 applies analogously to the scenario in which the server 220 acts as a client device that receives a protected item of software (i.e. one or more of the scripts 222) from a further server (not shown in FIG. 2), with the server 220 carrying out the steps 440 and 450 and the further server carrying out the steps 410, 420 and 430.

The initial item of software received at the step 410 may itself implement the security-related operation, with this being implemented in the initial item of software, at least in part, by at least one initial portion of code in the initial item of software. Thus, the step 420 of applying one or more software protection techniques to the initial item of software to thereby generate the protected item of software may comprise modifying at least the at least one initial portion of code to form the at least one protected portion of code for the protected item of software. This modifying may comprise (a) applying one or more white-box protection techniques to the at least one initial portion of code and/or (b) applying one or more node-locking techniques to the at least one initial portion of code.

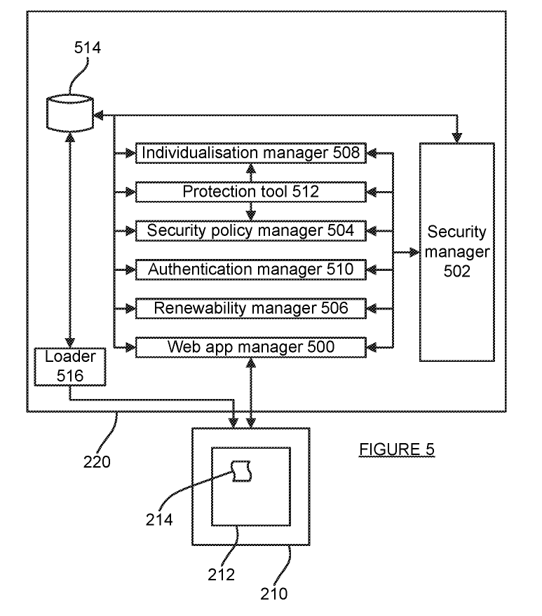

FIG. 5 schematically illustrates components (or modules or applications) executed by the server 220 to help implement embodiments of the invention. These components may, for example, be part of (or be provided by) one or more of the scripts 222 and/or the software protection application 224. It will be appreciated that some embodiments of the invention do not require, or do not use, all of the components shown in FIG. 5, and that the connections or data flow between the components shown in FIG. 5 may therefore be adjusted accordingly.

As shown in FIG. 5, the components executed by the server 220 may comprise: a web app manager 500, a security manager 502, a security policy manager 504, a renewability manager 506, an individualization manager 508, an authentication manager 510, a protection tool 512, a database 514, and a loader 516.

The web app manager 500 may be a general manager (or an interface) for handling requests for protected items of software 214 from client devices 210 (e.g. requests received via the network 230 as set out above). The web app manager 500 may communicate with the security manager 502 to request the security manager 502 to perform security coordination in relation to a received request for a protected item of software 214 (as explained in more detail shortly). The web app manager 500 may make (or help make) decisions (e.g. what levels of security or what types of protection to apply when generating the protected item of software 214 for the client device 210) in relation to this request for a protected item of software 214—these decisions could be based on, for example, an identity of the client device 210 (as determined by the web app manager 500, e.g. based on information in the request) and/or based on the nature or identity of the particular protected item of software 214 being requested. The web app manager 500 may select a specific instance (from a plurality of different/diversified instances that have been created) of the protected item of software 214 to provide to the client device 210. The web app manager 500 may load, or provide, the protected item of software 214 to the client device 210 via the network 230. Moreover, when the protected item of software 214 is executing on the client device 210, the web app manager 500 may interact with, or communicate with, the protected item of software 214 to dynamically handle any requests, including security requests, from the protected item of software 214.

The security manager 502 is responsible for controlling or coordinating server-side security for a protected item of software 214 when the protected item of software 214 is being created, or is being provided to the client device 214, or is being executed at the client device 214. As shall be explained in more detail shortly, when providing such control or coordination the security manager 502 may use other components (such as the security policy manager 504, the renewability manager 506, the individualization manager 508, the authentication manager 510, and the dynamic protection tool 512).

The database 514 acts as a repository or store of information or metadata about protected items of software 514, such as: (a) protection information which may, for example, identify the protections applied to the protected items of software 214 and/or keys or seeds used when applying such protections, etc. (b) general information about the protected items of software 214, such as origin, creation information, functionality, attributes, etc. The database 514 may store the protected items of software 214 themselves. Additionally, when two or more different/diversified versions of a protected item of software 214 are created (as explained later), these different/diversified versions may be stored in the database 214 (e.g. for subsequent access or provision to a client device 230). The database 514 may also store security components (additional code/modules) that may be used by, or included as part of, a protected item of software 214 (as explained later). Again, the database 514 may store different/diversified versions of such security components. The database 514 may store one or more security policies, as used and managed by the security policy manager 504. The database 514 may store other information, such as information used by the web app manager 500 and/or the security manager 502.

When an item of software is initially received or obtained at the step 410 of FIG. 4, it may be stored in the database 514. When that item of software has been modified at the step 420 of FIG. 4 to become a protected item of software, then that protected item of software may be stored in the database 514.

The security policy manager 504 is arranged to manage and enforce one or more security policies for a protected item of software. Such security policies may be specified by, for example, a creator of the item of software and/or an operator of the server 220. The security policy manager 504 may provide an interface (e.g. a webpage) that enables the specification, review and update of one or more security policies. The security policies may be stored in the database 514.

A security policy may be specific to, or may correspond to, one or more of: (a) a particular item of software; (b) a creator of one or more items of software (and, therefore, the security policy applies to all items of software created by that creator); (c) the operator of the server 220 (and, therefore, the security policy applies to all items of software provided by the server 220); (d) items of software with one or more particular attributes or properties, as specified by metadata for the items of software stored in the database 514, such as the functionality or a level of security desired etc. for the items of software (and, therefore, the security policy applies to all items of software with those one or more particular attributes or properties). A security policy may specify, for example, one or more of: (i) whether the protected item of software 214 can be copied; (ii) one or more properties (e.g. type/model or security characteristics/level/capabilities) that client devices 210 must have or comply with in order to be allowed to obtain a protected item of software 214; (iii) one or more properties (e.g. type/model or security characteristics/level/capabilities) that the browser 212 at the client device 210 must have or comply with in order for the client device 210 to be allowed to obtain a protected item of software 214; (iv) the nature of, and/or levels of, protection to be applied to an item of software in order to generate the protected item of software 214 that is to be ultimately provided to the client device 210; etc.

In some embodiments, in addition to the security policy manager 504 handling security policies when a protected item of software 214 is initially generated and/or provided to the client device 210, the security policy manager 504 may handle (i.e. process and/or enforce) security policies when the protected item of software 214 is executed at the client device 210. For example, during execution of the protected item of software 214 at the client device 210, the security policy manager 504 may receive information from the client device 210 (over the network 230 via the web app manager 500). Based on this received information, the security policy manager 504 may identify whether the execution of the protected item of software 214 complies with one or more applicable security policies (and take action if the execution does not comply with those one or more applicable security policies) and/or may guide necessary security actions (as set out in one or more applicable security policies) by coordinating with other components at the server 230 and/or the protected item of software 214.

Thus, the security manager 502 may use the security policy manager 504 to identify (or specify) one or more security policies relating to a protected item of software 214 being requested by, or being executed by, the client device 210. The security manager 502 (either itself or via one or more of the other components at the server 220) may then coordinate or apply one or more protections (or perform other security functionality) for the generation of, or for the continued execution of, the protected item of software 214, in line with the one or more security policies identified, or specified, by the security policy manager 504.

The renewability manager 506 performs the renewing, or updating, of protected items of software 214 at the client device 210 and/or security components used by protected items of software 214 at the client device 210. The renewability manager 506 may, therefore, perform renewing, or updating, of protected items of software 214 stored in the database 514 and/or security components for use by protected items of software 214 that are being stored in the database 514. This renewing, or updating, may be performed pro-actively (for example in accordance with an applicable security policy being enforced by the security policy manager 504 that could specify, for example, a period of time after which the client device 210 should have its protected item of software 214 and/or one or more security components used by its protected items of software 214 updated with a differently protected version (e.g. a diversified version) of that protected item of software 214 and/or one or more security components. Additionally, or alternatively, this renewing, or updating, may be performed in response to an newly-discovered attack or a newly-discovered weakness in one or more of the protections being used by the protected item of software 214 and/or one or more security components used by its protected items of software 214, in which case the server 220 may generate and provide updated/new versions of the protected item of software 214 stored in the database 514 and/or updated/new versions of one or more security components used by the protected item of software 214. Such renewing, or updating may, additionally or alternatively, be performed in response to a request received from the client device 210 (or from the protected item of software 214 itself or from one or more of the security components used by the protected item of software 214).

The renewability manager 506 may use the loader 516 to provide, as and when necessary, the updated items of software 214 and/or the updated security components to the client device 210 via the network 230.

Thus, the security manager 502 may use the renewability manager 506 to identify when such renewing, or updating, needs to be performed (either proactively or reactively). The security manager 502 (either itself or via one or more of the other components at the server 220) may then, based on the identification by the renewability manager 506, coordinate or apply one or more protections (or perform other security functionality) for the generation of updated/renewed protected items of software 214 and/or one or more updated/renewed security components for use by a protected item of software 214. Similarly, the security manager 502 (either itself or via one or more of the other components at the server 220) may, based on the identification by the renewability manager 506, coordinate the provision to the client device 210 of updated/renewed protected items of software 214 and/or one or more updated/renewed security components for use by a protected item of software 214.

The individualization manager 508 coordinates the individualization (or diversification) of a protected item of software 214 and/or one or more security components for use by a protected item of software 214. Here, the individualization may be to individualize in relation to one or more conditions/properties/attributes, such as one or more of: a particular user; a particular client device 210; a particular instance of a browser 212 at the client device 210; a particular date or time; etc. The individualization manager 508 may, therefore, provide input (e.g. as one or more parameters, such as one or more randomly generated seeds or keys) to the protection tool 512, where the protection tool 512 uses this input to control how protection is applied to an item of software to generate a protected item of software 214 (or to control the nature of the protections). This, essentially, enables different users, or different client devices 210, or different browsers 212 at different client devices 210, to receive the same “underlying” item of software or software functionality, but in the form of different/diversified instances of the protected item of software 214. Similarly, the same user, or the same client device 210 could receive different/diversified instances in response to requests for the protected item of software 214 issued to the server 220 at different dates/times.

The individualization manager 508 may also help ensure that there is a supply, in the database 514, of different/diversified instances of security components that may be used by protected items of software 214, so that the generation and provision of a protected item of software 214 can be carried out efficiently as and when such generation and provision is required.

Thus, the security manager 502 may therefore use the individualization manager 508 to provide input to the protection tool 512 as set out above, and/or to control the generation of a supply of different/diversified instances of security components that may be used by protected items of software 214, and/or to control the generation of a supply of different/diversified instances of protected items of software 214.

The authentication manager 510 may perform authentication processing. Such authentication processing may comprise one or more of authenticating a user, authenticating a client device 210, authenticating the browser 212 at the client device 210, etc. Methods of performing such authentication are known and shall not be described in further detail herein. The security manager 502 may use the authentication manager 510 to ensure that protected items of software 214 are only provided to users, or client devices 210 or browsers 212 that conform to one or more criteria (e.g. being a user or a device 210 that has paid to receive a protected item of software 214).

The protection tool 512 is responsible for applying one or more protections to an item of software to generate a protected item of software 214. (The same applies, analogously, to generating a protected security component based on initial software or code for the security component). As mentioned above, the protection tool 512 may receive input from the individualization manager 508, where this input causes the protection tool 512 to apply protections to an item of software to generate a specific (or different/diversified) version or instance of a protected item of software 214. Examples of how such diversification can be performed can be found in WO2011/120123, the entire disclosure of which is incorporated herein by reference. For example, when the protection tool 512 applies a protection to an item of software, this may involve generating random numbers or random mappings/functions or other random processing, and the input from the individualization manager 508 may comprise one or more values (e.g. keys or seeds) to initialize or seed a random number generator for use in such random processing. Additionally, or alternatively, when the protection tool 512 applies a protection to an item of software, this may involve using a cryptographic key (e.g. embedding a cryptographic key within the item of software or configuring the item of software to use a cryptographic key or encrypting a part of the item of software with a cryptographic key) and the input from the individualization manager 508 may comprise one or more cryptographic keys for such use accordingly. It will be appreciated, however, that this need not always be the case, so that the protection tool 512 does not need to use such individualization input from the individualization manager 508.

The protection tool 512 may obtain an item of software from the database 514 (or from some other source) and apply one or more protections to the item of software to generate the protected item of software 214. The protection tool 512 may then store the protected item of software 214 in the database 514.

In some embodiments, the security manager 502 uses the protection tool 512 to apply one or more protections to a (potentially unprotected) item of software received or obtained at the step 410. The resulting protected item of software 214 may then be stored in the database 514 and may then be provided to the client device 210 in response to a request from the client device 210. This is referred to as “static” protection, insofar as these protections applied to the item of software are not in response to, or based on, the request from the client device 210.

Additionally, or alternatively, the security manager 502 uses the protection tool 512 to apply one or more protections to a (potentially unprotected) item of software received or obtained from the database 514 at the step 410. Such an item of software may be an already-protected item of software, by virtue of having had the “static” protections applied thereto. The resulting protected item of software 214 may then be stored in the database 514 and may then be provided to the client device 210 in response to a request from the client device 210. The security manager 502 uses the protection tool 512 to apply these one or more protections in response to a request received from the client device 210 or, potentially, in response to the renewability manager 506 determining that new/updated protected items of software 214 need to be generated and distributed. This is referred to as “dynamic” protection, insofar as these protections are applied to the item of software in response to a need or request for a protected item of software 214.

Thus, it is possible that the server 220 may receive or obtain an item of software at the step 410, may apply static protections to that item of software, and then provide that statically-protected item of software 214 to the client device 210 (e.g. in response to a request from the client device 210). It is possible that the server 220 may receive or obtain an item of software at the step 410, may apply dynamic protections to that item of software (e.g. in response to a request from the client device 210 for an item of software), and then provide that dynamically-protected item of software 214 to the client device 210. It is possible that the server 220 may receive or obtain an item of software at the step 410, may apply static protections to that item of software, may apply dynamic protections to that statically-protected item of software (e.g. in response to a request from the client device 210 for an item of software), and then provide that statically-and-dynamically-protected item of software 214 to the client device 210.

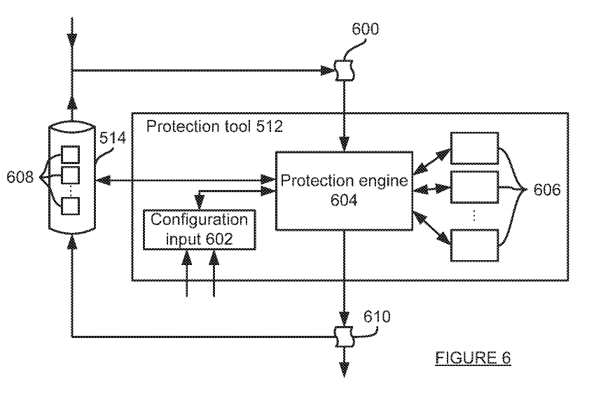

FIG. 6 schematically illustrates the protection tool 512 according to an embodiment of the invention. The protection tool 512 comprises a configuration input 602, a protection engine 604 and one or more protection sub-tools 606.

The configuration input 602 is arranged to receive configuration data for configuring or initializing the protection tool 512, i.e. to specify what protections to apply to an input item of software 600 to generate a protected item of software 610 and/or how a protection is to be applied to an input item of software 600. For example, the configuration input 602 may receive input from the individualization manager 508, where this input provides data (e.g. one or more configuration parameters) that enables (or causes) the protection tool 512 to generate a specific (i.e. different or diversified) instance of a protected item of software 610. This input could comprise, for example, one or more seeds or keys to be applied or used when applying one or more protections. Additionally, or alternatively, the configuration input 602 may receive input from the security policy manager 504 (either directly or via the security manager 502), where this input specifies which particular protection(s) to apply to the input item of software 600 and/or how (e.g. a level of security (such as a key size) or an order in which protections are to be applied). For example, a security policy, identified by the security policy manager 504 as being applicable to the input item of software 600, may specify that one or more particular protections need to be applied to that input item of software 600 and/or that one or more levels of protection (e.g. encryption key sizes, degrees of bijective mappings or data transformations, etc.) need to be used when applying protection to that input item of software 600—this information may then be passed to the protection tool 512 via the configuration input 602.

The configuration input 602 passes the configuration data to the protection engine 604. It will be appreciated, however, that the protection engine 604 may be arranged to generate some or all of the configuration data itself, without having had to receive the configuration data from an external source via the configuration input 602. For example, the protection engine 604 may itself generate random keys/seeds for use in applying one or more protections.

The protection engine 604 applies protection via use of one or more protection sub-tools 606 and/or by including code or software from (or based on) one or more security components 608. The protection engine 604 applies a protection initially to the input item of software 600 and, after the first protection has been applied, applies protection to the then “partially” protected item of software that has resulted from the application of one or more preceding protections, with this being performed until the final output protected item of software 610 is generated

The protection engine 604 may be arranged to analyze the input item of software 600 (and/or one of the above-mentioned “partially” protected item of software) to identify one or more weaknesses or vulnerabilities and, based on this analysis, identify one or more protection to apply to address (and hopefully counter) one or more of those identified weaknesses or vulnerabilities.

As mentioned, the protection engine 604 may use one or more of the protection sub-tools 606 to apply a corresponding protection to the input item of software 600 (or, after the first protection has been applied, to apply a corresponding protection to the then “partially” protected item of software). Examples of the protections applied by the protection sub-tools 606 shall be described shortly. The choice of which protection sub-tools 606 to use and/or the order in which those sub-tools 606 may be used by the protection engine 604 may be based, at least in part, on the input received by the configuration input 602 and/or may be based, at least in part, on standard or predetermined settings for the protection engine 604, which may be stored as part of the protection engine 604 (such as the protection engine 604 always being arranged to use a first protection sub-tool 606 before using a second protection sub-tool 606).

The protection engine 604 may include, as part of the protected item of software 610, one or more security components 608 (which could be software libraries or actors)—i.e. these security components 608 provide code or software (or enable the protection engine 604 to generate code or software) to be included within (or added or embedded into) the item of software 600 (and/or included within one of the above-mentioned “partially” protected item of software resulting from the application of one or more previous protections). Such security components 608 may provide one or more security functions or capabilities to the protected item of software 610. The security components 608 may be stored in the database 514 as shown in FIG. 6. Additionally, or alternatively, the security components 608 may be stored internally to the protection tool 512. Some or all of the security components 608 may themselves be, or comprise, protected items of software. For one or more of the security components 608, there may be multiple (diverse/different) versions of that security component 608, and the protection engine 604 may be arranged to select one of those versions to use when generating the protected item of software 610 (the selection could be based, for example, on the configuration data received via the configuration input 602).

The choice of which security components 608 to use may be based, at least in part, on the input received by the configuration input 602 and/or may be based, at least in part, on standard or predetermined settings for the protection engine 604, which may be stored as part of the protection engine 604.

The security components 608 and/or the protection sub-tools 606 may provide the following functionality.
One or more security components 608 and/or protection sub-tools 606 may provide protection against white-box attacks. There are numerous techniques, referred to herein as “white-box obfuscation techniques”, for transforming an item of software 600 so that it is resistant to white-box attacks. Examples of such white-box obfuscation techniques can be found, in “White-Box Cryptography and an AES Implementation”, S. Chow et al, Selected Areas in Cryptography, 9th Annual International Workshop, SAC 2002, Lecture Notes in Computer Science 2595 (2003), p 250-270 and “A White-box DES Implementation for DRM Applications”, S. Chow et al, Digital Rights Management, ACM CCS-9 Workshop, DRM 2002, Lecture Notes in Computer Science 2696 (2003), p 1-15, the entire disclosures of which are incorporated herein by reference. Additional examples can be found in US61/055,694 and WO2009/140774, the entire disclosures of which are incorporated herein by reference. Some white-box obfuscation techniques implement data flow obfuscation—see, for example, U.S. Pat. No. 7,350,085, U.S. Pat. No. 7,397,916, U.S. Pat. No. 6,594,761 and U.S. Pat. No. 6,842,862, the entire disclosures of which are incorporated herein by reference. Some white-box obfuscation techniques implement control flow obfuscation—see, for example, U.S. Pat. No. 6,779,114, U.S. Pat. No. 6,594,761 and U.S. Pat. No. 6,842,862 the entire disclosures of which are incorporated herein by. However, it will be appreciated that other white-box obfuscation techniques exist and that embodiments may use any white-box obfuscation techniques.
One or more security components 608 and/or protection sub-tools 606 may provide so-called “node-locking” functionality, i.e. preventing the protected item of software 610 from being executed on a client device 210 other than one or more intended client devices 210. For example, it is possible that protected the item of software 610 may be intended to be provided (or distributed) to, and used by, a particular client device 210 (or a particular set of client devices 210) and that it is, therefore, desirable to “lock” the item of software 600 to the particular client device(s) 210, i.e. to prevent the protected item of software 610 from executing on another client device. There are numerous techniques, referred to herein as “node-locking” protection techniques, for transforming the item of software 600 so that the protected item of software 610 can execute on (or be executed by) one or more predetermined/specific client devices 210 but will not execute on other client devices. Examples of such node-locking techniques can be found in WO2012/126077, the entire disclosure of which is incorporated herein by reference. However, it will be appreciated that other node-locking techniques exist and that embodiments may use any node-locking techniques.
One or more security components 608 and/or protection sub-tools 606 may help prevent the data generated (at run time) by the protected item of software 610 from being used on a client device 210 other than one or more intended client devices 210—i.e. a so-called “content node-locking” functionality. For example, a protection sub-tool 606 may be used to modify the software so that its execution is based on one or more properties (e.g. an identification number) of a client device 210; similarly, a security component 608 may be included to provide the protected item of software 610 with the ability to determine those one or more properties. Examples of content node-locking techniques can be found in PCT/CN2013/073393, PCT/EP2013/056512, PCT/CN2011/000417, and PCT/CA2011/50141, the entire disclosures of which is incorporated herein by reference.
A protection sub-tool 606 may be used to apply a digital watermark to the item of software 600 (and/or to code already existing in one of the above-mentioned “partially” protected item of software). Digital watermarking is a well-known technology. In particular, digital watermarking involves modifying an initial digital object to produce a watermarked digital object. The modifications are made so as to embed or hide particular data (referred to as payload data) into the initial digital object. The payload data may, for example, comprise data identifying ownership rights or other rights information for the digital object. The payload data may identify the (intended) recipient of the watermarked digital object, in which case the payload data is referred to as a digital fingerprint—such digital watermarking can be used to help trace the origin of unauthorised copies of the digital object. Digital watermarking can be applied to items of software. Examples of such software watermarking techniques can be found in U.S. Pat. No. 7,395,433, the entire disclosure of which is incorporated herein by reference. However, it will be appreciated that other software watermarking techniques exist and that embodiments may use any software watermarking techniques.
One or more security components 608 and/or protection sub-tools 606 may include functionality into the protected item of software 610, or may configure the protected item of software 610, to make it harder for an attacker to copy inputs to and/or outputs from the protected item of software 610 at run time of protected item of software. Examples of techniques for achieving this can be found in PCT/EP2014/067841, the entire disclosure of which is incorporated herein by reference.
One or more security components 608 and/or protection sub-tools 606 may include functionality into the protected item of software 610, or may configure the protected item of software 610, to help prevent unauthorized capturing of content that the protected item of software 610 renders at run time via an output device (e.g. screen or a speaker) of the client device 210. (As an example, so-called screen-grabbing can be prevented). Examples of techniques for achieving this can be found in PCT/EP2014/067841, the entire disclosure of which is incorporated herein by reference.
One or more security components 608 and/or protection sub-tools 606 may include functionality into the protected item of software 610, or may configure the protected item of software 610, to help prevent an attacker from discovering metadata or information about the protected item of software 610 and/or the client device 210 (for example, keeping communications from the client device 210 and/or from the protected item of software 610 anonymous). Examples of techniques for achieving this can be found in PCT/CA2010/000409, PCT/CA2009/001430, PCT/CA2012/000307, and https://en.wikipedia.org/wiki/Mix_network, the entire disclosures of which is incorporated herein by reference.
One or more security components 608 and/or protection sub-tools 606 may include functionality into the protected item of software 610, or may configure the protected item of software 610, to protect against so-called “protocol blocking” attacks and/or “protocol filter” attacks. Examples of techniques for achieving this can be found in PCT/EP2013/056704 and “Dust: A Blocking-Resistant Internet Transport Protocol” by Brandon Wiley (found at http://freehaven.net/anonbib/cache/wileydust.pdf and http://blanu.net/Dust.pdf), the entire disclosures of which is incorporated herein by reference.
One or more security components 608 and/or protection sub-tools 606 may include functionality into the protected item of software 610, or may configure the protected item of software 610, to protect against one or more other predetermined types of attack (such as JavaScript Cross Site Scripting (XSS)). Examples of techniques for achieving this can be found in U.S. Pat. No. 7,730,322 and https://www.owasp.org/index.php/XSS_(Cross_Site_Scripting)_Preven tion_Cheat_Sheet , the entire disclosures of which is incorporated herein by reference.
A protection sub-tool 606 may be used to digitally sign some or all of the item of software 610 (or some/all of one of the above-mentioned “partial” protected items of software resulting from the application of one or more previous protections). A security component 608 may be included as part of the protected item of software 610 to verify the digital signature. The protected item of software 610, when being executed at the client device 210, may use this security component check or verify its own digital signature. The protected item of software 610 may then be arranged to not execute, or not provide desired functionality to a user of the client device 210, if the result of this check fails to successfully verify the digital signature; i.e. the protected item of software 610 may then be arranged to only execute, or to only provide desired functionality to a user of the client device 210, if the result of this check is that the digital signature is verified as authentic (indicating that signed part of the protected item of software 610 has not been modified). Methods of generating and verifying digital signatures are well-known.
A protection sub-tool 606 may be arranged to blend or mix code from one or more of the security components 608 with code already existing in the item of software 600 (and/or code already existing in one of the above-mentioned “partially” protected item of software resulting from the application of one or more previous protections). This may help obscure the boundaries between the existing code and the code for the newly-introduced security component(s) 608, thereby making it harder for an attacker to analyze and overcome/avoid one or more of the protections being applied. Examples of such boundary-blending techniques can be found in PCT/CA2012/000251, PCT/CA2010/00409, PCT/CA2010/00666, PCT/CA2008/00331, PCT/CA2008/000333, the entire disclosures of which is incorporated herein by reference.
One or more security components 608 and/or protection sub-tools 606 may include functionality into the protected item of software 610, or may configure the protected item of software 610, to protect against (or prevent) an attacker using a debugger at the client device 210 when the client device 210 is executing the protected item of software 610 (i.e. at run time of the protected item of software 610)—this will make it harder for an attacker to analyze the protected item of software 610 dynamically, i.e. during run time. Examples of techniques for achieving this can be found in PCT/EP2014/056335, PCT/EP2014/056422, PCT/CN2013/000352, and PCT/CA2012/000134, the entire disclosures of which is incorporated herein by reference.
One or more security components 608 and/or protection sub-tools 606 may include functionality into the protected item of software 610, or may configure the protected item of software 610, to provide or to enable secured loading of the protected item of software 610, for example securely loading the protected item of software 610 into a Java virtual machine at the client device 210. Examples of techniques for achieving this can be found in PCT/CA2012/000307 and PCT/CN2014/74356, the entire disclosures of which is incorporated herein by reference.
One or more security components 608 and/or protection sub-tools 606 may include functionality into the protected item of software 610, or may configure the protected item of software 610, to provide functionality for authenticating a user of the protected item of software 610 (either online or offline authentication). User authentication techniques are well-known.
One or more security components 608 and/or protection sub-tools 606 may include functionality into the protected item of software 610, or may configure the protected item of software 610, to provide the protected item of software 610 with the ability to securely store data (e.g. in an encrypted or transformed form) on the client device 210 so that the secured data cannot be accessed (or read and successfully interpreted) other than via a protected item of software 610. Examples of techniques for achieving this can be found in EP2227015, U.S. Pat. No. 7,506,177, U.S. Pat. No. 6,594,761, and U.S. Pat. No. 6,842,862, the entire disclosures of which is incorporated herein by reference.
One or more security components 608 and/or protection sub-tools 606 may include functionality into the protected item of software 610, or may configure the protected item of software 610, to provide the protected item of software 610 with the ability to securely operate on such securely store data at the client device 210 without having to first “unsecure” (e.g. decrypt or un-transform) the securely stored data. Examples of techniques for achieving this can be found in EP2227015, and PCT/EP2013/056617, the entire disclosures of which is incorporated herein by reference.
One or more security components 608 and/or protection sub-tools 606 may include functionality into the protected item of software 610, or may configure the protected item of software 610, to provide the protected item of software 610 with the ability to convert securely store data so that that data can be used by another version of the protected item of software 610 (which may potentially be executed at a different client device 210), i.e. the ability to share secured data without having to first “unsecure” (e.g. decrypt or un-transform) the securely stored data. Examples of techniques for achieving this can be found in EP2227015, the entire disclosure of which is incorporated herein by reference.
One or more security components 608 and/or protection sub-tools 606 may include functionality into the protected item of software 610, or may configure the protected item of software 610, to provide the protected item of software 610 with the ability to detect, at run time of the protected item of software 610, that an attack is being launched against the protected item of software 610 and to take an appropriate counter-measure. Examples of techniques for achieving this can be found in PCT/EP2014/056335, PCT/EP2014/056422, PCT/CN2013/000352, and PCT/CA2012/000134, the entire disclosures of which is incorporated herein by reference.
One or more security components 608 and/or protection sub-tools 606 may include functionality into the protected item of software 610, or may configure the protected item of software 610, to provide the protected item of software 610 with remote verification functionality (e.g. the ability to communicate with one or more verification servers or systems via the network 230). A verification system may request, and cause, the protected item of software 610 to perform one or more checks or verifications or diagnostics (for example, providing the remote verification system with details of the environment (such as an identification of the browser 210 and/or the client device 210 being used for executing the protected item of software 610), or providing the remote verification system with data for indicating or checking the integrity of the protected item of software 610, e.g. a checksum or hash value of code of the protected item of software 610). The protected item of software 610 may be arranged to respond to such a request and, if the verification system determines that the protected item of software 610 failed the verification, the protected item of software 610 may be arranged to respond to one or more further requests from the verification system (e.g. an instruction to terminate execution). Examples of techniques for achieving this remote verification functionality can be found in PCT/EP2014/056335 and PCT/CA2012/000134, the entire disclosures of which is incorporated herein by reference.
One or more security components 608 and/or protection sub-tools 606 may include functionality into the protected item of software 610, or may configure the protected item of software 610, to provide the protected item of software 610 with the ability to request, from the server 220, one or more updates to the protected item of software 610 (or one or more of its security components) in accordance with a security policy. For example, a security component 606 may be included that: checks, at run time, a security policy; determines whether, based on that the security policy, one or more updates are needed; and if one or more updates are needed, coordinates with the renewability manager 506 to receive or obtain the one or more updates. Examples of techniques for achieving this can be found in PCT/CA2012/000307 and PCT/CA213/000288, the entire disclosures of which is incorporated herein by reference.

Methods of applying the one or more software protection techniques to an initial item of software to thereby generate a protected item of software are set out in Annex A below.

### Modifications

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

### ANNEX A

Over recent years there has been a large increase in the number of end user computer devices for which programmers provide software, much of this increase being in the realm of devices for mobile telephony and mobile computing, including smart phones, tablet computers and the like, but also in the realm of more traditional style desktop computers as well as computers embedded in other manufactured goods such as cars, televisions and so forth. A large part of the software provided to such devices is in the form of applications commonly referred to as “apps”, and this software may typically be provided in the form of native code, scripting languages such as JavaScript, and other languages such as Java.

Often, such software, and data or content which the software is used to mediate to a user, is at risk of compromise if the software is not suitably protected using various software protection techniques. For example, such techniques may be used to make it very difficult for an attacker to extract an encryption key which could be used to gain unauthorised access to content such as video, audio or other data types, and may be used to make it very difficult for an attacker to replicate software for unauthorised use on other devices.

However, the use of such software protection techniques can lead to a reduction in the performance of the software, for example decreasing execution speed, increasing the amount of memory needed to store the software on a user device, or increasing the memory required for execution. Such software protection techniques may also be difficult to apply across a wide range of different software types, for example pre-existing software written in different source code languages or existing in particular native code formats.

It would be desirable to be able to provide protection against attacks for items of software, and to provide such protection across a range of software representations such as different source code languages and native code types, while also maintaining good levels of performance of the software on end user devices. It would also be desirable to deliver software suitably protected in this way for use on multiple different platform types.

We therefore describe a unified security framework in which the advantages of software tools in a first collection which are used for translation between representations, for optimization, compilation and so forth, are combined with the advantages of software tools in a second collection which are used for protection of software. In one example, the software tools in the first collection may be tools of the LLVM project, which generally operate using the LLVM intermediate representation. However, tools from other collections which operate using other intermediate generalisations may be used, for example tools from the Microsoft common language infrastructure, which typically use the common intermediate language CIL. Below, the intermediate representation used by the software tools in the first collection will be denoted as a first intermediate generalisation. Note that software tools in the first collection may also include tools for protection of software, such as binary rewriting protection tools.

An intermediate representation is a software representation which is neither originally intended for execution on an end user device, nor originally intended for use by a software engineer in constructing original source code, although either such activity is of course possible in principle. In the described below, neither the original software input to the unified security framework, nor the transformed software output for use on end user devices is cast in an intermediate representation.

The software tools in the second tool collection use a different intermediate generalisation, which is typically better suited, or originally intended for use by software tools which apply security protection transformations to items of software processed by the unified security framework. This intermediate representation is generally denoted below as the second intermediate representation, and is different to the first intermediate representation. The second intermediate representation may be designed in such a manner such that source code in languages such as C and C++ can be readily translated into the second intermediate representation, and from which source code in the same or similar languages can be readily reconstructed, by suitable conversion tools.

More generally, the unified security framework is described in which software tools for applying security transformations to items of software are provided such that multiple security transformation steps may be carried out, for example successively on an item of software, in multiple different intermediate representations. The unified security framework may also provide software tools for applying optimization transformations to items of software such that multiple optimization transformation steps may be carried out, for example successively on an item of software, in multiple different intermediate representations.

The described arrangements may be used to accept an input item of software in any input language or native code / binary representation for optimization and protection, and to output the protected and optimized item of software in various forms including any desired native code / binary representation, JavaScript or a subset of JavaScript, etc. In some examples the input representation, for example a particular binary code, may be the same as the output representation, thereby carrying out optimization and protection on an existing binary code item of software.

To this end, we describe a method comprising carrying out optimization of an item of software in a first intermediate representation, and carrying out protection of the item of software in a second intermediate representation which is different to the first intermediate representation.

The optimization in the first intermediate representation may be carried out both before and after carrying out protection in the second intermediate representation, and the method may therefore comprise converting the item of software from the first intermediate representation to the second intermediate representation after carrying out optimization a first time and before subsequently carrying out protection, and converting from the second intermediate representation to the first intermediate representation after carrying out protection and before subsequently carrying out optimization a second time.

Similarly, the protection in the second intermediate representation may be carried out both before and after carrying out optimization in the first intermediate representation, and the method may therefore comprise converting the item of software from the second intermediate representation to the first intermediate representation after carrying out protection a first time and before subsequently carrying out optimization, and converting from the first intermediate representation to the second intermediate representation after carrying out optimization and before subsequently carrying out protection a second time.

Steps of protection and optimization in the relevant intermediate representations can be carried out alternately any number of times, starting with either protection or optimization, and proceeding with one or more further steps in an alternating fashion.

As mentioned above, the first intermediate representation may be LLVM intermediate representation, LLVM IR, although other intermediate representations could be used such as Microsoft CIL.

More generally, we describe a method to carry out optimization of an item of software using optimization steps carried out in one or more intermediate representations, and carrying out protection of the item of software using protection steps in one or more intermediate representations some or all of which may be the same as or different to the intermediate representations used for carrying out the optimization.

Optimization of the item of software may comprise various types of optimization, for example for one or more of size, runtime speed and runtime memory requirement of the item of software. Techniques to achieve such optimizations may include vectorization, idle time, constant propagation, dead assignment elimination, inline expansion, reachability analysis, protection break normal and other optimizations.

Protection of the item of software in the second intermediate representation comprises applying one or more protection techniques to the item of software, in particular security protection techniques which protect program and/or data aspects of the software from attack. Such techniques may include, for example, white box protection techniques, node locking techniques, data flow obfuscation, control flow obfuscation and transformation, homomorphic data transformation, key hiding, program interlocking, boundary blending and any of the above-mentioned protections that the protection tool 512 is arranged to apply, as described above with reference to FIG. 6. The techniques used may be combined together in various ways to form one or more tools, for example as a cloaking engine implemented as part of an optimization and protection toolset.

The item of software is provided in an input representation which is typically different to both of the first and second intermediate representations. The method therefore may involve converting the item of software from the input representation to the first intermediate representation before carrying out the optimization, and typically also before carrying out the protection mentioned above. In some examples, the item of software in the input representation is converted to the second intermediate representation and then converted from the second intermediate representation before the first optimisation, and optionally also before the protection is carried out.

The input representation may be a source code representation such as C, C++, Objective-C, Java, JavaScript, C#, Ada, Fortran, ActionScript, GLSL, Haskell, Julia, Python, Ruby and Rust. However, the input representation may instead be a native code representation, for example a native code (i.e. a binary code) representation for a particular processor family such as any of the x86, x86-64, ARM, SPARC, PowerPC, MIPS, and m68k processor families. The input representation could also be a hardware description language (HDL). As is well-known, an HDL is a computer program language that may be used to program the structure, design and operation of electronic circuits. The HDL may, for example, be VHDL or Verilog, although it will be appreciated that many other HDLs exist and could be used in examples instead. As HDLs (and their uses and implementations) are well-known, they shall not be described in more detail herein, however, more detail can be found, for example, at http://en.wikipedia.org/wiki/Hardware_description_language, the entire disclosure of which is incorporated herein by reference.

When the above optimization and protection processes have been carried out, the item of software may be converted to an output representation. This stage of processing may also include further optimization and/or protection stages. In some examples, converting the item of software to an output representation comprises compiling (and typically also linking) the item of software into the output representation, for example into a native code representation. Further binary protection techniques may then also be applied to the item of software after the compiling and linking.

Before compilation, the item of software may be first converted from the first to the second intermediate representation and on to a source code representation which is passed to the compiler, or the item of software could be passed to the compiler directly in the first intermediate representation. In the first case, a compiler operating on the source code representation, such as a C/C++ compiler could be used. In the second case an LLVM compiler could be used if the first intermediate representation is LLVM IR. In any case, the compiler may be an optimizing compiler in order to provide a further level of optimization to the protected item of software.

Converting the item of software to an output representation may also comprise applying a binary rewriting protection tool to the item of software in the first intermediate representation before compiling, and/or such a tool may be applied at other times in the process.

Instead of compiling the item of software into a native code representation, the item of software may instead be converted into a script representation, and especially into a script representation which can be executed on an end user device. Conveniently, a JavaScript representation may be used for this purpose because such a script can be executed directly by a web browser on the end user device. More particularly, an asm.js representation, which is a subset of JavaScript, may be used, because asm.js is adapted for particularly efficient execution on end user devices. For example, if the first intermediate representation is the LLVM IR, then the Emscripten tool may be used to convert the item of software from the first intermediate representation to an asm.js representation.

If the input representation is a hardware description language then the output representation may typically be in a corresponding representation able to describe the electronic circuit at a more hardware oriented level, such as in a netlist. Where processing aspects such as compilation and linking are described herein, the skilled person will appreciate that when the described arrangements are used with an HDL input representation, equivalent steps such as synthesis using appropriate tools may be used, and that suitable software tools applicable to HDL work may be used for the protection and optimization aspects of the described arrangements. The output item of software is then a description of the electronic system with suitable obfuscation/protection and optimization steps applied.

The item of software may be any of a variety of items of software, such as an application for execution on a user device, a library, a module, an agent, and so forth. In particular, the item of software may be an item of security software such as a library, module or agent containing software for implementing security functions such as encryption/decryption and digital rights management functions. The method may be applied to two such items of software, and one of these items of software may use functionality in the other for example through a procedure call or other reference. Similarly, an item of software optimized and protected according to the described examples may utilize or call security related or protected functionality in lower layers such as a systems layer or hardware layer. Similarly, the item of software may describe an electronic system, and be provided for input to the example arrangements in an HDL.

We also describe a method of protecting an item of software comprising applying one or more protection techniques to the item of software, and optimizing the item of software using one or more LLVM tools, and this aspect of the may be combined with the various options mentioned elsewhere herein. For example, the one or more protection techniques may be applied to the item of software using a protection component arranged to operate using an intermediate representation which is different to the LLVM intermediate representation, and the method may further comprise converting the item of software between one or more representations and the LLVM intermediate representation using LLVM tools. The method may be used to output a protected and optimized item of software in one of asm.js or a native code representation.

Following processing of an item of software as discussed above, the item of software may be delivered to one or more user devices for execution. The item of software may be delivered to user devices in various ways such as over a wired, optical or wireless network, using a computer readable medium, and in other ways.

The software for providing the discussed methods and apparatus may be provided on one or more computer readable media, over a network or in other ways, for execution on suitable computer apparatus, for example a computer device comprising memory and one or more processors, or a plurality of such devices, in combination with suitable input and output facilities to enable an operator to control the apparatus such as a keyboard, mouse and screen, along with persistent storage for storing computer program code for putting the described arrangements into effect on the apparatus.

We therefore also describe computer apparatus for protecting an item of software, comprising an optimizer component arranged to carry out optimization of the item of software in a first intermediate representation, such as LLVM IR, and a protector component arranged to carry out protection of the item of software in a second intermediate generalisation.

The apparatus may be arranged such that the optimizer component carries out optimization in the first intermediate representation of the item of software both before and after the protector component carries out protection in the second intermediate representation of the item of software.

The optimization component may comprise one or more LLVM optimization tools.

The protection component may be arranged to apply to the item of software one or more protection techniques comprising one or more of white box protection techniques, node locking techniques, data flow obfuscation, control flow obfuscation and transformation, homomorphic data transformation, key hiding, program interlocking, boundary blending, or any of the above-mentioned protections that the protection tool 512 is arranged to apply, as described above with reference to FIG. 6.

The apparatus may further comprise an input converter arranged to convert the item of software from an input representation to LLVM IR, and the input representation may be one of a binary or native code representation, a byte code representation, and a source code representation. The apparatus may further comprise a compiler and linker arranged to output the optimized and protected item of software as binary code, and an output converter arranged to output the optimized and protected item of software as asm.js code.

We also describe a unified cloaking toolset comprising a protection component, an optimizer component, and one or more converters for converting between intermediate representations used by the protection component and the optimizer component. The optimizer component may comprise one or more LLVM optimizer tools, and the unified cloaking toolset may comprises one or more LLVM front end tools for converting from an input representation into LLVM intermediate representation. The unified cloaking toolset, protection components and/or optimizer components may be provided to apply transformations to an item of software in more than one intermediate representation.

The unified cloaking toolset may also implement the various other aspects of the described examples as set out herein, for example with the protection component implementing one or more of the following techniques: white box protection techniques, node locking techniques, data flow obfuscation, control flow obfuscation and transformation, homomorphic data transformation, key hiding, program interlocking, boundary blending and any of the above-mentioned protections that the protection tool 512 is arranged to apply, as described above with reference to FIG. 6; the unified cloaking toolset further comprising a compiler and linker arranged to compile and link into a native code representation; and the unified cloaking toolset further comprising an output converter for converting to an output representation which is a subset of JavaScript.

This description also covers one or more items of software which have been optimized and protected using the described methods and/or apparatus, and such items of software may be provided, stored or transferred in computer memory, on a computer readable medium, over a telecommunications or computer network, and in other ways.

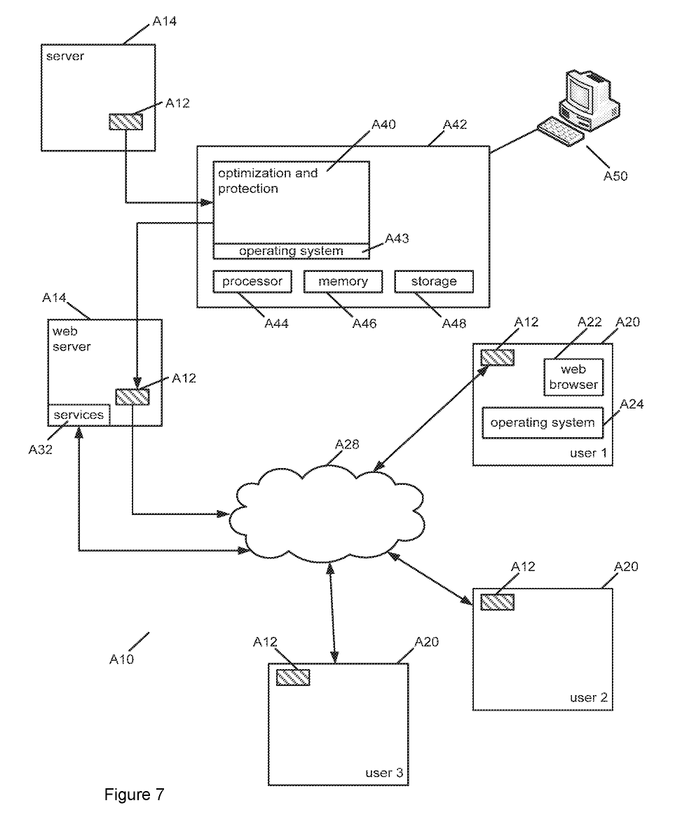

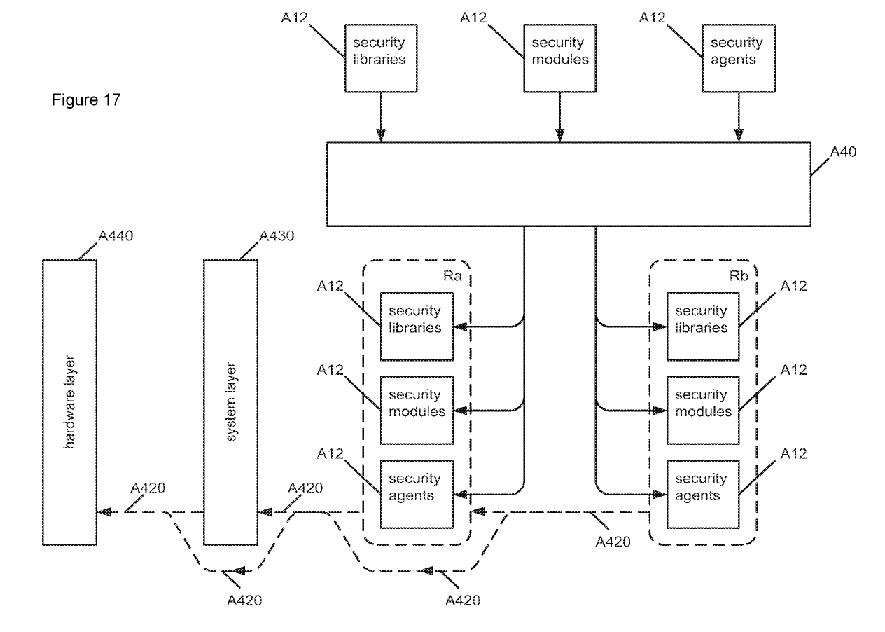

Various examples will now be described, with reference to FIGS. 7-18.

In the description that follows and in the figures, certain examples are described. However, it will be appreciated that the ideas in this discussion are not limited to the examples that are described and that some implementations of the ideas may not include all of the features that are described below. Referring now to FIG. 7 there is shown an exemplary computer system. An item of software A12 is provided, for example by a server A14 where it has been previously stored. The item of software A12 may be intended for various different purposes, but in the system of FIG. 7 it is an application (sometimes referred to as an app, depending on aspects such as how the application is delivered and how it is used in the context of the user device and wider operating environment) which is intended for execution and use on one or more of a plurality of user computers A20. The user computers A20 may be personal computers, smart phones, tablet computers, or any other suitable user devices. Typically, such a user device A20 will include an operating system A24 providing services to other software entities running on the user device such as a web browser A22. The item of software A12 may be delivered to the user device in various forms, but typically may be in the form of native executable code, a generic lower level code such as Java byte code, or a scripting language such as Java script. Typically, a generic lower level code or a scripting language software item A12 will be executed within or under the direct control of the web browser A22. An item of software A12 in native executable code is more likely to be executed under the direct control of the operating system A24, although some types of native code such as Google NaCl and PNaCl are executed within a web browser environment.

The item of software A12 of FIG. 7 may typically be delivered to the one or more user devices over a data network A28 such as the Internet by a remote web server A30, although other delivery and installation arrangements may be used. The illustrated web server, or one or more other servers, may also provide data, support, digital rights management and/or other services A32 to the user devices A20 and in particular to the item of software A12 executing on the user devices A20.

The item of software A12 may be vulnerable to attack and compromise in various ways on the user devices A20, whether before, during or after execution on those devices A20. For example, the item of software may implement digital rights management techniques which an attacker may try to compromise for example by extracting an encryption key or details of an algorithm which can enable future circumvention of the digital rights management techniques for that particular item of software, for particular digital content, and so forth.

The system A10 therefore also provides an optimization and protection toolset A40 which is used to optimize and protect the item of software A12 before delivery to the user devices A20. In FIG. 7 the optimization and protection toolset A40 acts upon the item of software A12 before the item of software A12 is delivered to the web server A32, but it could be implemented in the server A14, the web server A30, in a development environment (not shown) or elsewhere. The optimization and protection toolset A40 in FIG. 7 is shown as executing on a suitable computer apparatus A42 under the control of an operating system A43. The computer apparatus A42 will typically include one or more processors A44 which execute the software code of the optimization and protection toolset A42 using memory A46, under control of a user through input/output facilities A50. The computer apparatus A42 and functionality of the optimization and protection toolset A40 could be distributed across a plurality of computer units connected by suitable data network connections. Part of all of the software used to provide the optimization and protection toolset A40 may be stored in non-volatile storage A48, and/or in one or more computer readable media, and/or may be transmitted over a data network to the computer apparatus A42.

Note that the item of software A12 to be optimized and protected may also be a component for use in with or by another item of software such as an application. To this end, the item of software A12 could be, for example, a library, a module, an agent or similar.

Thus, relating FIG. 7 to FIGS. 2 and 5: the system A10 of FIG. 7 may correspond to the system 200 of FIG. 2; the user computers A20 of FIG. 7 may be client devices 210 of FIG. 2; the server A30 of FIG. 7 may be the server 220 of FIG. 2; the item of software A12 delivered to the user computer A20 in FIG. 7 may be the protected item of software 214 of FIG. 2; the web browser A22 of FIG. 7 may be the browser 212 of FIG. 2; the toolset A40 may be (or may comprise) the protection tool 512 of FIG. 5.

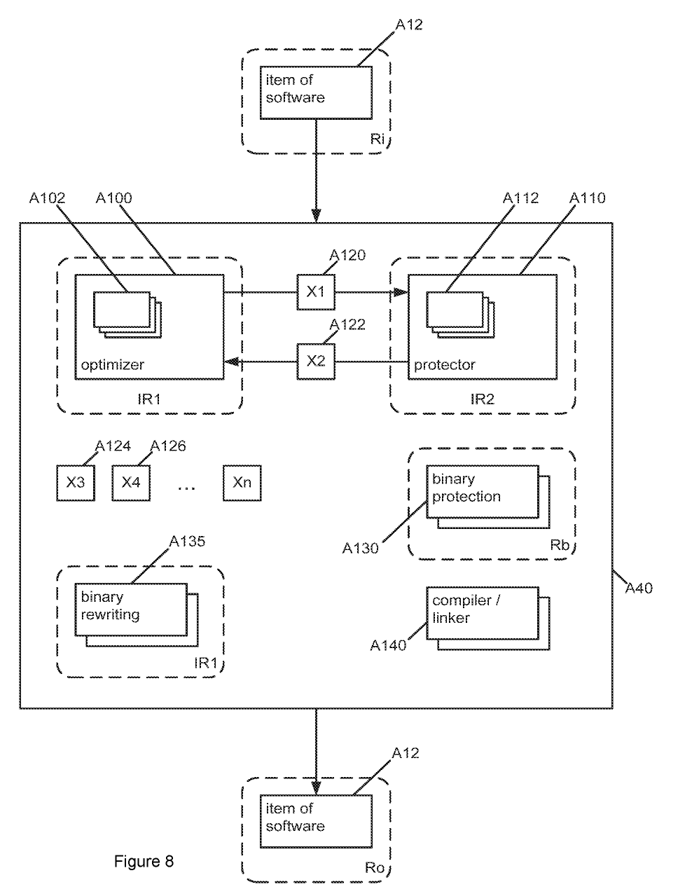

An exemplary implementation of the optimization and protection toolset A40 is shown schematically in FIG. 8. The optimization and protection toolset A40 includes an optimizer component A100 and a protector component A110. The optimizer component A100 is adapted to implement optimization techniques on the item of software A12. The optimizer component A100 is configured to implement such techniques in a first intermediate representation IR1, so that the item of software A12 needs to be rendered into this first intermediate representation IR1 before the optimizer component A100 carries out optimization of the item of software. The protector component A110 is adapted to implement protection techniques on the item of software A12. The protection component is configured to implement such techniques in a second intermediate representation IR2, so that the item of software A12 needs to be rendered into this second intermediate representation before the protector component A110 carries out protection of the item of software A12. The first and second intermediate representations are different representations to each other. Typically, the protector component A110 is not able to operate on the item of software when in the first intermediate representation, and the optimizer component is not able to operate on the item of software when in the second intermediate representation.

Each of the optimizer component A100 and protection component A110 may be implemented as a plurality of subcomponents A102, A112 in the optimization and protection toolset A40. The subcomponents of a particular component may provide different and/or replicated functionality with respect to each other, for example such that the overall role of a component may be distributed in various ways within the software of the optimization and protection toolset A40. The subcomponents A112 may correspond to the security components 608 and/or the protection sub-tools 606 of FIG. 6.

The optimization and protection toolset A40 also provides a plurality of converters which are adapted to convert an item of software A12 from one representation to another. These converters include a first converter component A120 arranged to convert an item of software from the first intermediate representation IR1 used by the optimizer component A100 to the second intermediate representation IR2 used by the protector component A110, and a second converter component A122 arranged to convert an item of software from the second intermediate representation IR2 used by the protector component A100 to the first intermediate representation IR1 used by the optimizer component 110. Of course, the first and second converter components A120, A122 may be combined in a single function software unit such as a single module, executable or object oriented method if desired.

The item of software A12 is provided to the optimization and protection toolset 40 in an input representation Ri. This input representation may be one of any of a number of different representations, for example either the first or second intermediate representations IR1, IR2, or another representation such as a source code representation, a binary code representation, and so forth. Similarly, item of software A12 is output from the optimization and protection toolset 40 in an output representation Ro. This output representation may also be one of any number of different representations, for example either of the first or second intermediate representations IR1, IR2, or another representation such as a source code representation, a binary code representation, and so forth.

The optimization and protection toolset A40 may also include one or more further components, each arranged to operate on the item of software A12 in a particular representation. Such components may for example include a binary protection component A130 providing binary protection tools arranged to operate on the item of software A12 in a binary representation Rb, a binary rewriting protection component A135 providing binary rewriting protection tools arranged to operate on the item of software A12 in a binary representation or some other representation such as the first intermediate representation, and so forth.

In addition to the first converter component A120 and the second converter component A122, the optimization and protection toolset A40 is therefore also provided with other converter components A124, A126 also shown in FIG. 8 as X3 . . . Xn, which are used for converting the item of software A12 between various representations as required. By way of example, one such converter component A124, A126 may convert from a C/C++ source code representation to the second intermediate representation IR2, and another such converter component may convert from the second intermediate representation IR2 back to the C/C++ source code representation.

FIG. 8 also shows, as part of the optimization and protection toolset A40 one or more compiler or compiler and linker components A140 that can be used to compile and link the item of software A12 for example to convert the item of software A12 typically into a native or binary code representation, or another suitable target representation.

Examples of source code representations which could be used for the input representation Ri, and other representations within the optimization and protection toolset A40, include C, C++, Objective-C, C#, Java, JavaScript, Ada, Fortran, ActionScript, GLSL, Haskell, Julia, Python, Ruby, and Rust, although the skilled person will be aware of many others. The input representation Ri may instead be a native or binary code, a byte code and so forth, or possibly one of the first and second intermediate representations.

Examples of representations which could be used for the output representation Ro include native code representations for direct execution on a user device, including native code representations such as PNaCl and NaCl which are adapted for execution under the control of a web browser, byte code representations such as Java byte code, representations adapted for interpreted execution or run time compiling such as Java source code, script representations such as JavaScript and subsets of JavaScript such as asm.js, and possibly the first or second intermediate representations.

The first intermediate representation IR1 may typically be selected as an intermediate representation convenient for, adapted or otherwise selected for carrying out optimization techniques. In particular, the first intermediate representation may be LLVM IR (LLVM Intermediate Representation). The LLVM project, which is known to the skilled person and discussed for example at the LLVM website “http://llvm.org”, provides a collection of modular and reusable compiler and tool-chain technologies that:

(i) introduce a well specified general purpose intermediate representation (LLVM IR) that supports a language-independent instruction set and type system;

(ii) provide the middle layers of a complete compiler system and infrastructure that take an item of software in LLVM IR and emit a highly optimised version of the item of software in LLVM IR ready for compile-time, link-time, run-time and “idle-time” optimization of programs written in a wide range of source code representations;

(iii) support rich LLVM front-end tools for source code and other representations that include not only C and C++, but also other popular programming languages such as the source code languages mentioned above, as well as Java byte-code etc.;

(iv) by a set of LLVM back-end tools, supports many other popular platforms and systems at present, and will support more mobile platforms in the near future; and

(v) work with OpenGL and low-end and high-end GPUs.

Other representations suitable for use as the first intermediate representation include Microsoft Common Intermediate Language (CIL). The second intermediate representation IR2 may typically be selected as an intermediate representation convenient for, adapted or otherwise selected for carrying out protection techniques. The second intermediate representation may, for example be designed and implemented in such a manner that source code in particular languages, for example C and C++, can be readily translated into the second intermediate representation, and such that the source code in the same or similar languages can be readily constructed from the second intermediate representation.

Optimization techniques carried out by the optimizer may include techniques to increase the speed of execution of the item of software, to reduce execution idle time, reduce the memory required for storage and/or execution of the item of software, increase usage of the core or GPU, and similar. These and other optimization functions are conveniently provided by the LLVM project. Techniques to achieve such optimizations may include vectorization, idle time, constant propagation, dead assignment elimination, inline expansion, reachability analysis, protection break normal and other optimizations.

The aim of the protector component is to protect the functionality or data processing of the item of software and/or to protect data used or processed by the item of software. This can be achieved by applying cloaking techniques such as homomorphic data transformation, control flow transformation, white box cryptography, key hiding, program interlocking, boundary blending and any of the above-mentioned protections that the protection tool 512 is arranged to apply, as described above with reference to FIG. 6.

In particular, the item of software after processing by the protector component will provide the same functionality or data processing as before such processing—however, this functionality or data processing is typically implemented in the protected item of software in a manner such that an operator of a user device cannot access or use this functionality or data processing from item of software in an unintended or unauthorised manner (whereas if the user device were provided with the item of software in an unprotected form, then the operator of the user device might have been able to access or use the functionality or data processing in an unintended or unauthorised manner). Similarly, the item of software, after processing by the protector component, may store secret information (such as a cryptographic key) in a protected or obfuscated manner to thereby make it more difficult (if not impossible) for an attacker to deduce or access that secret information (whereas if a user device were provided with the item of software in an unprotected form, then the operator of the user device might have been able to deduce or access that secret information).

For example:
The item of software may comprise a decision (or a decision block or a branch point) that is based, at least in part, on one or more items of data to be processed by the item of software. If the item of software were provided to a user device A20 in an unprotected form, then an attacker may be able to force the item of software to execute so that a path of execution is followed after processing the decision even though that path of execution were not meant to have been followed. For example, the decision may comprise testing whether a program variable B is TRUE or FALSE, and the item of software may be arranged so that, if the decision identifies that B is TRUE then execution path P_{T} is followed/executed whereas if the decision identifies that B is FALSE then execution path P_{F} is followed/executed. In this case, the attacker could (for example by using a debugger) force the item of software to follow path P_{F} if the decision identified that B is TRUE and/or force the item of software to follow path P_{T} if the decision identified that B is FALSE. Therefore, in some examples, the protector component A110 aims to prevent (or at least make it more difficult) for the attacker to do this by applying one or more software protection techniques to the decision within the item of software.
The item of software may comprise one or more of a security-related function; an access-control function; a cryptographic function; and a rights-management function. Such functions often involve the use of secret data, such as one or more cryptographic keys. The processing may involve using and/or operating on or with one or more cryptographic keys. If an attacker were able to identify or determine the secret data, then a security breach has occurred and control or management of data (such as audio and/or video content) that is protected by the secret data may be circumvented. Therefore, in some examples, the protector component A110 aims to prevent (or at least make it more difficult) for the attacker to identify or determine the one or more pieces of secret data by applying one or more software protection techniques to such functions within the item of software.

A “white-box” environment is an execution environment for an item of software in which an attacker of the item of software is assumed to have full access to, and visibility of, the data being operated on (including intermediate values), memory contents and execution/process flow of the item of software. Moreover, in the white-box environment, the attacker is assumed to be able to modify the data being operated on, the memory contents and the execution/process flow of the item of software, for example by using a debugger—in this way, the attacker can experiment on, and try to manipulate the operation of, the item of software, with the aim of circumventing initially intended functionality and/or identifying secret information and/or for other purposes. Indeed, one may even assume that the attacker is aware of the underlying algorithm being performed by the item of software. However, the item of software may need to use secret information (e.g. one or more cryptographic keys), where this information needs to remain hidden from the attacker. Similarly, it would be desirable to prevent the attacker from modifying the execution/control flow of the item of software, for example preventing the attacker forcing the item of software to take one execution path after a decision block instead of a legitimate execution path. There are numerous techniques, referred to herein as “white-box obfuscation techniques”, for transforming the item of software so that it is resistant to white-box attacks. Examples of such white-box obfuscation techniques can be found, in “White-Box Cryptography and an AES Implementation”, S. Chow et al, Selected Areas in Cryptography, 9^{th} Annual International Workshop, SAC 2002, Lecture Notes in Computer Science 2595 (2003), p 250-270 and “A White-box DES Implementation for DRM Applications”, S. Chow et al, Digital Rights Management, ACM CCS-9 Workshop, DRM 2002, Lecture Notes in Computer Science 2696 (2003), p 1-15, the entire disclosures of which are incorporated herein by reference. Additional examples can be found in US61/055,694 and WO2009/140774, the entire disclosures of which are incorporated herein by reference. Some white-box obfuscation techniques implement data flow obfuscation—see, for example, U.S. Pat. No. 7,350,085, U.S. Pat. No. 7,397,916, U.S. Pat. No. 6,594,761 and U.S. Pat. No. 6,842,862, the entire disclosures of which are incorporated herein by reference. Some white-box obfuscation techniques implement control flow obfuscation—see, for example, U.S. Pat. No. 6,779,114, U.S. Pat. No. 6,594,761 and U.S. Pat. No. 6,842,862 the entire disclosures of which are incorporated herein by. However, it will be appreciated that other white-box obfuscation techniques exist and that examples of the may use any white-box obfuscation techniques.

As another example, it is possible that the item of software may be intended to be provided (or distributed) to, and used by, a particular user device A20 (or a particular set of user devices A20) and that it is, therefore, desirable to “lock” the item of software to the particular user device(s) A20, i.e. to prevent the item of software from executing on another user device A20. Consequently, there are numerous techniques, referred to herein as “node-locking” protection techniques, for transforming the item of software so that the protected item of software can execute on (or be executed by) one or more predetermined/specific user devices A20 but will not execute on other user devices. Examples of such node-locking techniques can be found in WO2012/126077, the entire disclosure of which are incorporated herein by reference. However, it will be appreciated that other node-locking techniques exist and that examples may use any node-locking techniques.

Digital watermarking is a well-known technology. In particular, digital watermarking involves modifying an initial digital object to produce a watermarked digital object. The modifications are made so as to embed or hide particular data (referred to as payload data) into the initial digital object. The payload data may, for example, comprise data identifying ownership rights or other rights information for the digital object. The payload data may identify the (intended) recipient of the watermarked digital object, in which case the payload data is referred to as a digital fingerprint—such digital watermarking can be used to help trace the origin of unauthorised copies of the digital object. Digital watermarking can be applied to items of software. Examples of such software watermarking techniques can be found in U.S. Pat. No. 7,395,433, the entire disclosure of which are incorporated herein by reference. However, it will be appreciated that other software watermarking techniques exist and that examples may use any software watermarking techniques.

It may be desirable to provide different versions of the item of software to different user devices A20. The different versions of the item of software provide the different user devices A20 with the same functionality—however, the different versions of the protected item of software are programmed or implemented differently. This helps limit the impact of an attacker successfully attacking the protected item of software. In particular, if an attacker successfully attacks his version of the protected item of software, then that attack (or data, such as cryptographic keys, discovered or accessed by that attack) may not be suitable for use with different versions of the protected item of software. Consequently, there are numerous techniques, referred to herein as “diversity” techniques, for transforming the item of software so that different, protected versions of the item of software are generated (i.e. so that “diversity” is introduced). Examples of such diversity techniques can be found in WO2011/120123, the entire disclosure of which are incorporated herein by reference. However, it will be appreciated that other diversity techniques exist and that examples may use any diversity techniques.

The above-mentioned white-box obfuscation techniques, node-locking techniques, software watermarking techniques and diversity techniques are examples of software protection techniques. It will be appreciated that there are other methods of applying protection to an item of software (for example, any of the above-mentioned protections that the protection tool 512 is arranged to apply, as described above with reference to FIG. 6). Thus, the term “software protection techniques” as used herein shall be taken to mean any method of applying protection to an item of software (with the aim of thwarting attacks by an attacker, or at least making it more difficult for an attacker to be successful with his attacks), such as any one of the above-mentioned white-box obfuscation techniques and/or any one of the above-mentioned node-locking techniques and/or any one of the above-mentioned software watermarking techniques and/or any one of the above-mentioned diversity techniques and/or any of the above-mentioned protections that the protection tool 512 is arranged to apply, as described above with reference to FIG. 6.

There are numerous ways in which the protector component A110 may implement the above-mentioned software protection techniques within the item of software A260. For example, to protect the item of software, the protector module A110 may modify one or more portions of code within the item of software and/or may add or introduce one or more new portions of code into the item of software A220. The actual way in which these modifications are made or the actual way in which the new portions of code are written can, of course, vary—there are, after all, numerous ways of writing software to achieve the same functionality.

The binary protection component A130 is for accepting the software item in the form of native or binary code or byte code after compiling by the compiler and linker A140, and applies binary protection techniques such as integrity verification, anti-debugging, code encryption, secured loading, and secured storage. The binary protection component then typically repackages the item of software into a fully protected binary with necessary security data that can be accessed and used during its loading and execution on user devices A20.

Thus, for an item of software in which a developer can access all source code, the optimization and protection toolset A40 can be used to apply source code protection tools to the source code of the application first in the second intermediate representation, using the protection component A112, and then to apply binary protection to the binary that is already protected by using source code protection techniques. Applying such protection to an item of software in both source code and binary code domains results in a more effectively protected item of software.

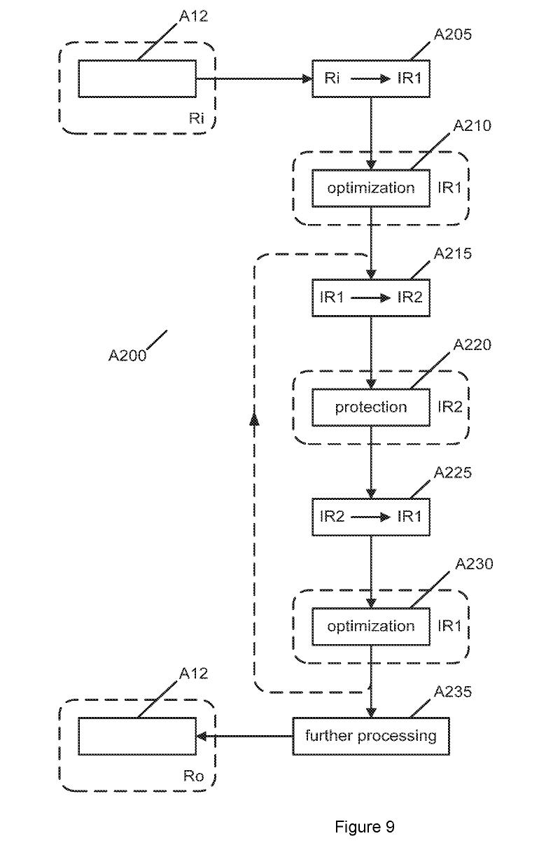

FIG. 9 illustrates some of the work flows A200 which may be implemented using the optimization and protection toolset A40. An item of software is provided to the toolset in an input representation Ri. This representation might typically be a source code or binary code representation as discussed above. The item of software is converted to the first intermediate representation at step A205. This might involve using a single converter component A120-A128, or two or more converter components. Typically, the item of software might be converted from the input representation Ri directly into the first intermediate representation, or from the input representation Ri into the first intermediate representation via another representation such as the second intermediate representation.

The item of software in the first intermediate representation IR1 is then optimized at step A210 using the optimizer component A100 of FIG. 8, and then converted to the second intermediate representation IR2 at step A215, using the first converter A120 of FIG. 2. The item of software in the second intermediate representation IR2 is then protected at step A220 using the protector component A110 of FIG. 8, and then converted back to the first intermediate representation IR1 at step A225 using the second converter A122 of FIG. 8.

The item of software in the first intermediate representation IR1 is then optimized again at step A230 using the optimizer component A100 of FIG. 8. It may then be subject to various aspects of further processing at step A235 before being output in the output representation Ro. Aspects of further processing may include one or more of compiling and linking, binary protection, conversion to other representations and so forth.

A broken flow arrow in the figure indicates that after the second optimization step A230, the work flow A200 may return to steps A215 for conversion back to the second intermediate representation, and one or more further steps of protection and optimization.

The work flow A200 of FIG. 9 can be varied in different ways. For example, the item of software may be optimized just once, either before or after the step of protection A220, and the step of further processing A235 may be omitted or include multiple steps. Either protection or optimization may be carried out before the other, and any number of further steps of optimization and protection may be carried out. Conversion from the input representation Ri to the representation used for optimization IR1 may include multiple conversion steps for example a conversion from Ri to IR2 followed by a conversion from IR2 to IR1. The further processing step A235 may include other optimization and/or protection steps, for example a binary rewriting protection step.

More specific examples of how the optimization and protection toolset A40 of FIG. 8 and the work flows such as those of FIG. 9 may be implemented will now be described. In these particular examples, the first intermediate representation is typically the LLVM IR discussed above. This enables expansion of the scope of native application protection for better performance and security, and also to open up new security possibilities for much larger scope of operation of the optimization and protection toolset A40.

It has become apparent to the inventors that there are conflicting issues between security and performance in preparing an item of software for distribution to a plurality of user devices A20. In general, protected software introduces necessary redundancy and overhead that will slow down the performance of the software in the protected, and especially cloaked form. the more protection techniques that are applied to the item of software, the more significant is the impact on performance. Therefore, performance and security need to be balanced.

Typical protection techniques may transform static program dependencies into partially static and partially dynamic dependencies. This prevents completely static attacks that are usually much easier to carry out than dynamic attacks. However, it also introduces a limitation that these protection techniques can break certain optimization capabilities which rely on analysis of properties of static dependencies. Because of this limitation, protection and optimization strategies need to make choice between less security / protection but better optimization for example in terms of execution speed and/or smaller program size, and more security / protection but less optimization.

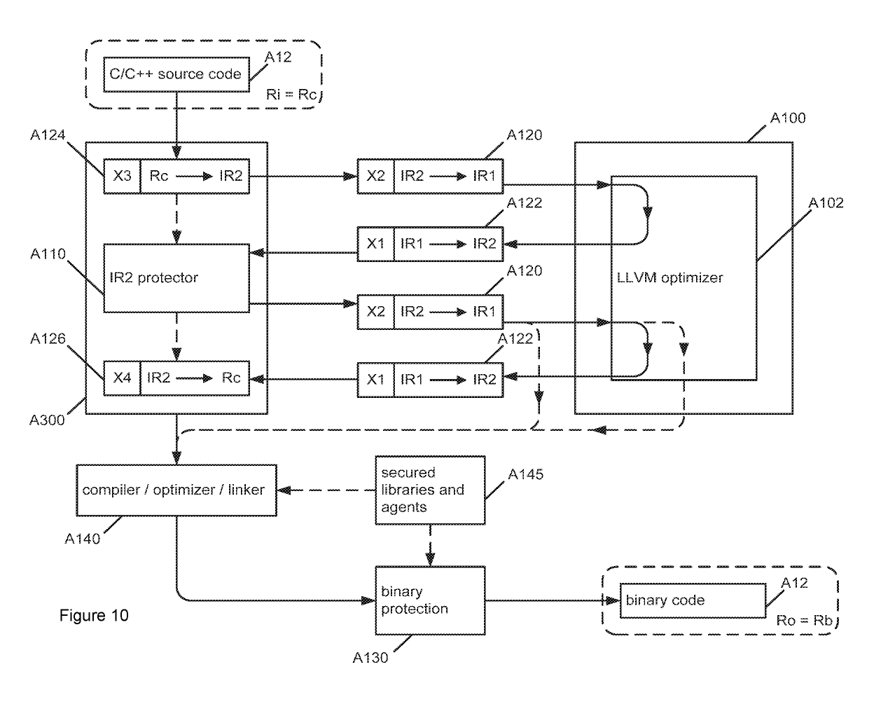

FIG. 10 illustrates a work flow which can be implemented using the optimization and protection toolset A40. The item of software is provided to the optimization and protection toolset A40 in an input representation Ri which is a C/C++ source code representation Rc. This is passed to a toolset component grouping A300 which consists of a converter X3 from representation Rc to the second intermediate representation IR2, the protector component A110, and a converter X4 from the second intermediate representation IR2 back to the source code representation Rc. If no LLVM optimization in the first intermediate representation is to take place, then the item of software can be passed through each of these functions sequentially to protect the item of software before being passed to the compiler, optimizer and linker A140, and then on to binary protection component A130 to output the item of software in an output representation which is a native/binary code representation Rb. A set of secure libraries and agents A145 is also provided for use in compiling/linking the item of software 1A2, and if required for use by the binary protection component A130.

The toolset component grouping A300 is complemented by the optimizer component A100, shown here for the purposes of clarity as a single subcomponent A102 implementing one or more LLVM optimization tools, although multiple subcomponents A102 could be used for example with a different subcomponent, multiple subcomponents, or different combinations of subcomponents being used at each stage of optimization . The X1 and X2 converters of FIG. 8 are then used to convert the item of software from the second intermediate representation formed using the X3 converter 124 and/or as output by the protector component A112 in the toolset component grouping A300, to the first intermediate representation for use by the LLVM optimization tools, and to convert the item of software following optimization by the LLVM optimization tools for protection by the protector component A110 and/or for conversion by the X4 converter back to the Rc representation.

Some alternative work flow pathways are illustrated in FIG. 10 using broken lines. For example, following processing by protector component A110 and conversion to the IR1 representation, the item of software can be sent directly to the compiler, optimizer and linker A140 without a second step of processing by the optimizer component A100. Similarly, after a second step of processing by the optimizer component A100, the item of software can be sent directly to the compiler, optimizer and linker A140 without conversion by the X1 and X4 converters, if the compiler, optimizer and linker A140 is able to handle input in the first intermediate representation.

The X1 and X2 converters therefore provide a bridge between the domain of the protection techniques provided by the protector component in the second intermediate representation, and the domain of the optimization techniques provided by the LLVM optimization tools in the first intermediate representation, thereby integrating these two areas of operation of the optimization and protection toolset A40. This approach also helps to resolve the conflict between protection and optimization discussed above, because the optimization and protection toolset A40 can leverage the power of the available LLVM optimization tools and techniques, to provide optimization both before and after the protection techniques are applied by the protection component A110. By enabling optimization at multiple levels, it is possible to remove the limitation between security and performance so that both better security and improved performance can both be achieved for the same item of software A12.

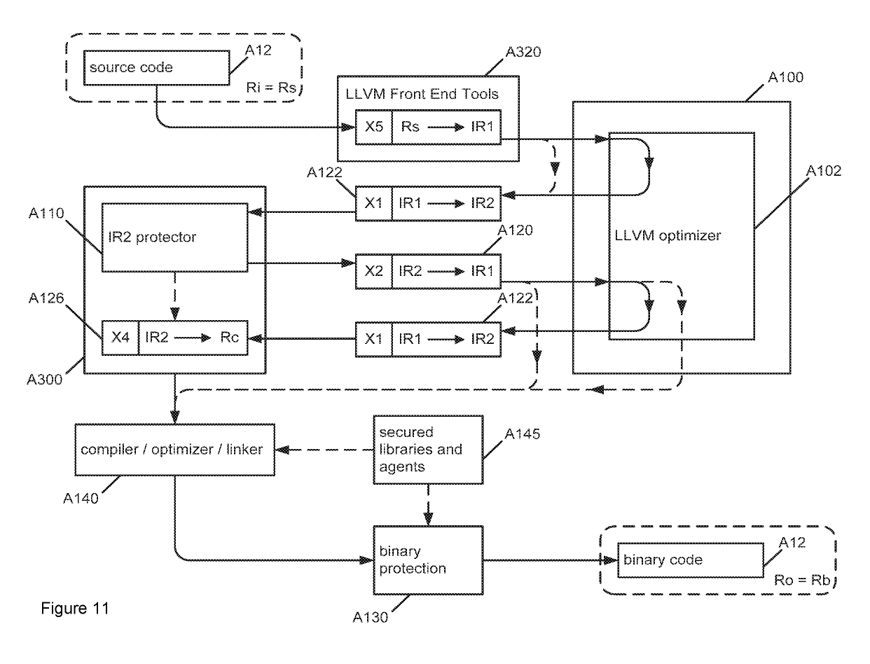

FIG. 11 illustrates another work flow which can be implemented using the optimization and protection toolset A40. In this figure, the item of software is provided to the optimization and protection toolset 40 in an input representation Ri which is a source code representation Rs. The source code representation Rs could be, for example, Objective-C, Java, JavaScript, C#, Ada, Fortran, ActionScript, GLSL, Haskell, Julia, Python, Ruby or Rust. The item of software is passed to a converter X5 which converts the source code representation Rs into the first intermediate representation. The converter X5 may be provided as part of a set of LLVM front-end tools A320 providing conversion to LLVM IR from a wide variety of source code representations. The item of software now in LLVM IR can be passed to the optimizer component A100 for a first step of optimization by the LLVM optimizer tools, or directly to the X1 converter (as shown by a broken line) for conversion to the second intermediate representation before being passed to the protector component A110. The remaining parts of FIG. 11 correspond to FIG. 10. Note that the toolset component grouping 300 of FIG. 11 is not shown as including the X3 converter because it is not necessary in the work flow of FIG. 11, but it could nonetheless be included in this grouping if desired.

Since the very rich set of available LLVM front-end tools A320 can convert many different languages into LLVM IR, and thereby leverage LLVM compilation facilities to obtain sophisticated analysis and better performance, these LLVM front-end tools can be used, as illustrated in FIG. 11, to extend the front-end capabilities of the optimization and protection toolset A40 to convert program source code in a large set of programming languages into the second intermediate representation via the first intermediate representation where the protection techniques of the protector component A110 can be applied.

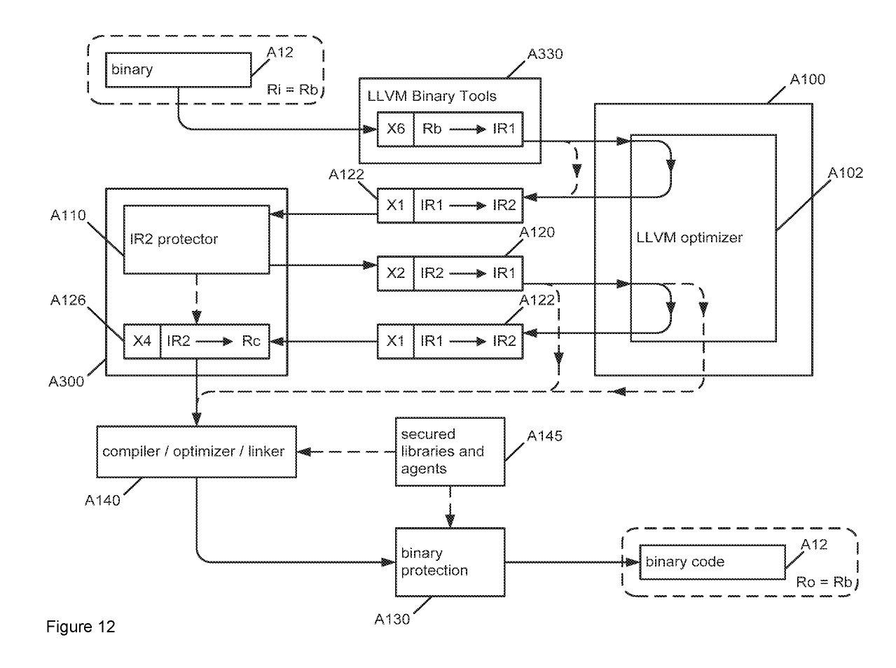

FIG. 12 illustrates another work flow which can be implemented using the optimization and protection toolset A40. In this figure, the item of software is provided to the optimization and protection toolset A40 in an input representation Ri which is a native/binary representation Rb, for execution on particular platform or class of user device A20. The binary representation Rb could be, for example, any of x86, x86-64, ARM, SPARC, PowerPC, MIPS, and m68k binary representations. The item of software is passed to a converter X6 which converts the binary representation Rb into the first intermediate representation. The converter X6 may be provided as part of a set of LLVM binary tools A330 providing conversion to LLVM IR from a wide variety of binary representations. The remaining parts of FIG. 12 correspond to FIGS. 10 and 11.

By using LLVM binary tools in this way, an item of software in native/binary code can be converted into LLVM IR form, before being converted in the second intermediate representation for input into the protector component A300 for protection techniques such as cloaking to be applied. If the output representation Ro is a binary code for a different target platform than that of the input representation binary code, the optimization and protection toolset A40 can easily be used to reach this goal of an output for a different target platform at the same time as applying the required protection techniques, by suitable configuration of the complier, optimizer and linker A140.

LLVM compiler middle layer tools include sophisticated program analysis capabilities, such as more precise alias analysis, pointer escape analysis, and dependence analysis, that can provide rich program properties and dependencies that can be used to transform programs for different purposes. The binary rewriting protection component A135 illustrated in FIG. 8 provides one or more binary rewriting protection tools which accept an item of software in LLVM IR form, make obfuscating transformations by leveraging LLVM's program analysis functionalities, and results in a more secure version of the item of software in the LLVM IR. The binary rewriting protection component A135 can enhance protection of the item of software in a number of different ways, including stand-alone binary rewriting protection, binary rewriting protection with binary protection tools, and binary rewriting protection with both source cloaking tools and binary protection tools:

Stand-alone binary rewriting protection—generally, binary protection protects binary code in binary forms, and some such protection techniques need to work on binary representations, for example integrity verification, secure loading, and dynamic code encryption. Also, binary protection can apply certain kinds of transformations if required program information becomes available. However, existing binary protection tools tend to have limited support of analysis capacity such that very limited binary transformations can be done directly in binary form. Instead, a binary rewriting protection tool can be adapted to act on an item of software in an intermediate representation such as LLVM IR, in which much more sophisticated program analysis supports can be leveraged, thereby applying many transformation techniques that cannot be easily applied directly to software in a binary representation.

In a stand-alone mode, an item of software in an unprotected binary code representation is translated into the LLVM IR using one or more LLVM binary tools A330, and then the binary rewriting protection component A135 is used to apply certain program transformations to the item of software by interacting with LLVM program analysis tools. The rewritten item of software in LLVM IR is then translated into a protected binary code representation by using an LLVM IR to binary converter, a compiler, optimizer and linker, or in other ways.

Binary rewriting protection with binary protection tools—in this mode, an item of software provided to the optimization and protection toolset A40 in a binary code representation can be obfuscated into a protected binary representation by using the binary rewriting protection component A135. The item of software can then be further protected by using general binary protection tools such as provided by binary protection component A130 of FIG. 8. Combining different layers of protection together in this way by using both binary rewriting protection and binary protection leads to a more secure item of software A12.

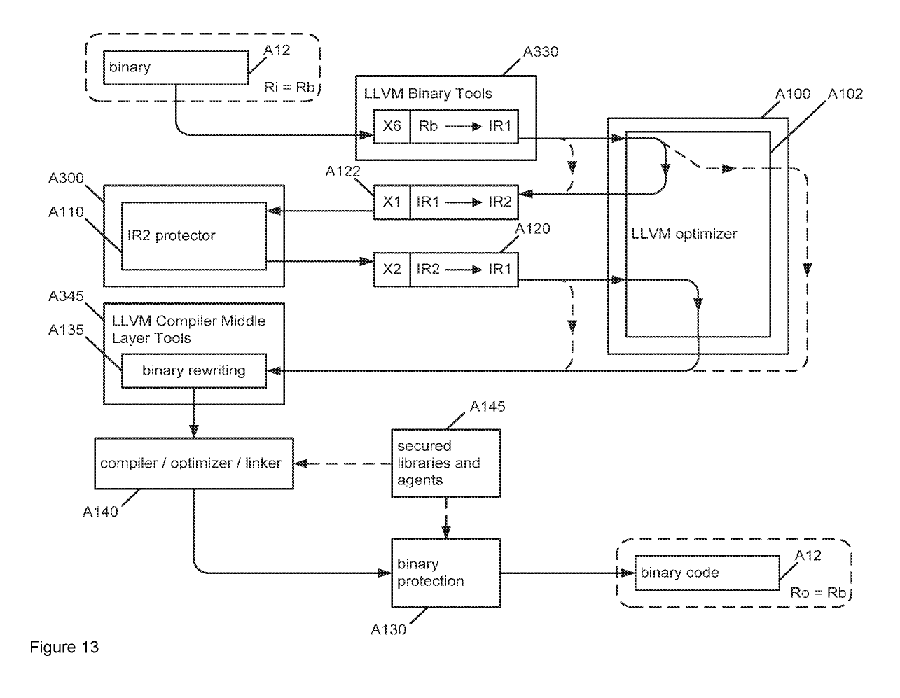

Binary rewriting protection with both source level protection and binary protection—in general, protection processing of source code type representations such as the second intermediate representation discussed above can provide more comprehensive and deeper data flow and control flow protection. FIG. 13 illustrates this using a work flow similar to that of FIG. 12 in which LLVM binary tools are used to convert an item of software A12, provided to the optimization and protection toolset A40 in a binary representation, to the first intermediate representation. Additionally in FIG. 13, the item of software output from the optimizer component A102, or alternatively directly from converter X2, after action of the protector component A112, is directed to the binary rewriting protection tool A135. After operation of the binary rewriting protection tool A135 the item of software is then passed on to the compiler, optimizer and linker A140 as previously described. The binary rewriting protection tool A135 is an example of an LLVM compiler middle layer tool A345 which can be used in this arrangement. As shown by broken lines in FIG. 13, the item of software may instead be directed straight to the binary rewriting protection tool after the first optimization without processing by the protector component A112 or a second stage of optimization, or may be processed in a manner which omits either the first or second steps of optimization.

A web application is an application that uses a web browser as a client environment. A web application is typically coded in a browser-supported programming language such as JavaScript, combined with a browser-rendered markup language such as HTML, and depends on its host web browser to render it executable. “asm.js” is a restricted subset of JavaScript, discussed for example at the website http://asmjs.ord. “asm.js” supports C-like computations, but because it is a subset of JavaScript it runs correctly in any web browser supporting JavaScript, not requiring any further special support. The subset used by asm.js makes it easy to recognize low-level operations using trivial methods of type inference. “asm.js” does depend on the extensions needed to support WebGL (buffers and type arrays such as Ulnt32, INt 16 and so forth) in order to support low-level structures, arrays, etc., but these are usually available in the hosting web browser. That a JavaScript program conforms to the “asm.js” representation can be marked in the JavaScript file using the “use asm” directive. The hosting web browser can then ignore this directive is explicit support for “asm.js” is absent, or can check the program for compliance with the “asm.js” representation if support is available. If support is available in the web browser, then asm.js code can run at greatly increased speed and efficiency compared with usual JavaScript, typically through compilation of the asm.js code into a native binary code representation.

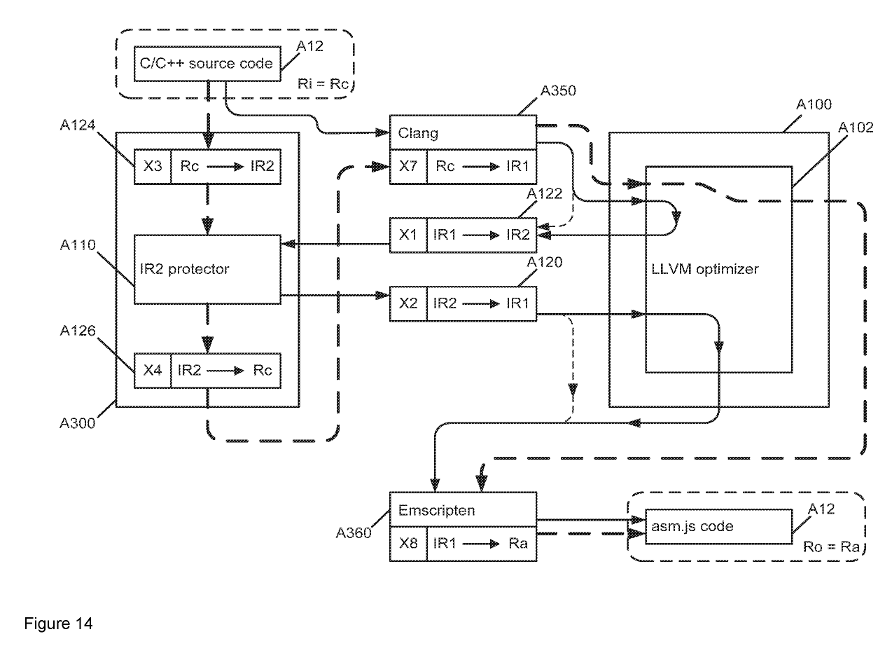

Tools are provided in the prior art for converting source code representations such as C and C++ into the asm.js representation. One such tool chain would consist of the Clang tool (see http://clang.llvm.org which converts C and C++ representations into the LLVR IR, and the Emscripten tool (see https://github.com/kripken/emscripten) which converts LLVM IR into the asm.js representation. LLVM optimization tools can be applied as part of this tool chain to effect optimization before application of the Emscripten tool. FIG. 14 illustrates how the optimization and protection toolset A40 can be used to optimize and protect an item of software provided in a C/C++ source representation Rc, and output the item of software in an asm.js representation Ra. The work flows of FIG. 14 follow similar schemes to those of FIGS. 10 to 13.

According to a first work flow route shown in heavy broken lines, the item of software input in the C/C++ representation Rc is passed to the toolset component grouping A300 where it is converted to the second intermediate representation by converter X3, then protected by protection component A112, and then converted back to the C/C++ representation Rc. The protected item of software is then passed to a Clang component A350 denoted as X7 which converts the C/++ source code representation Rc to the first intermediate representation IR1, typically LLVM IR. This representation is passed to the LLVM optimizer A310 forming part of the optimizer component A102, and then to an Emscripten component A360 denoted as X8 which converts the first intermediate representation to an asm.js representation Ra for output.

According to a second work flow route generally shown in solid lines, the item of software input in the C/C++ representation Rc is passed first to the Clang component A350 denoted as X7 which converts the C/++ source code representation Rc to the first intermediate representation IR1, typically LLVM IR. This representation is passed to the LLVM optimizer A310 forming part of the optimizer component A102, and then to the first converter A122 denoted as X1 for conversion to the second intermediate representation for passing to the protector component A112. After processing by the protector component A112 the item of software is passed to the second converter A120 denoted as X2 for conversion back to the first intermediate representation and then to the optimizer component A102 for a second stage of optimization. Finally, the item of software is passed to the Emscripten component A360 denoted as X8 which converts the first intermediate representation to an asm.js representation Ra for output. Some alternatives within this work flow are shown in light broken lines, by which either the first or second step of optimization can be omitted.

By using the optimization and protection toolset A40 to implement C/C++ to asm.js conversion including protection and optimization it is possible to both develop new items of software such as web apps in C/C++ for delivery to user devices in asm.js, and also to migrate existing items of software in C/C++ into protected and optimized asm.js representations. Because asm.js enabled browsers can perform much stronger run-time optimization than if general JavaScript is used, the optimized and protected asm.js item of software can be run at high speed. Indeed, tests by the inventors have shown that items of software written in C/C++ and processed using the optimization and protection toolset A40 as discussed above to form optimized and protected asm.js code can perform better than a corresponding item of software originally written in native code. This indicates excellent performance of the optimizers used in the optimization and protection toolset A40. Although FIG. 14 shows the use of the optimization and protection toolset

A40 to accept an item of software input in C or C++, other source code representations such as Object-C, Java, JavaScript, C# and so forth can be used for the input representation Ri by using a different LLVM front end tool in place of the Clang tool A350 shown in FIG. 14, with subsequent steps of optimization and protection as already discussed and final conversion to the asm.js representation Ra. This opens up many new opportunities to migrate existing applications in languages other than C/C++ into web applications, or to develop new web applications in these languages that can be made available for use in browser environments.

Similarly, the work flows shown in FIG. 14 can be changed to accept an input item of software in a native/binary representation Rb by replacing the Clang tool A350 with one or more LLVM binary tools A330 (for example as already discussed in connection with FIG. 13). A significant advantage of such a work flow is that existing items of software in native code representations can be migrated into web apps for running in browser environments (for example HTML5) with the enhanced security provided by the protection component A112, while maintaining performance for example in terms of speed of execution.

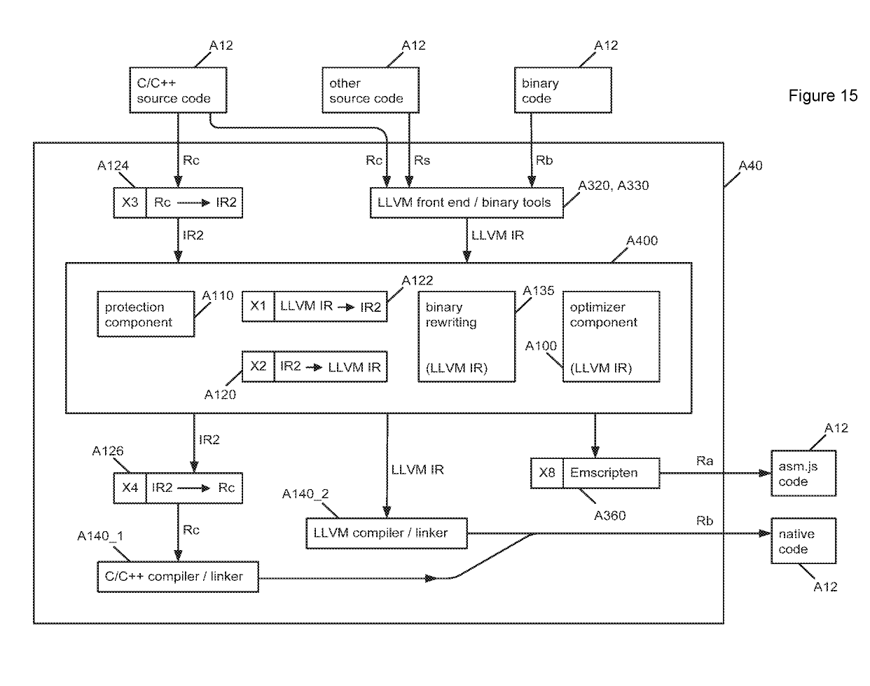

FIG. 15 illustrates again the optimization and protection toolset A40 already shown in FIG. 8, but now with some other specific detail and aspects reflecting the work flows discussed in connection with FIGS. 9-14. For example, the optimization and protection toolset A40 illustrated in FIG. 15 makes specific reference to use of LLVM IR as the first intermediate representation. Adopting a technology framework such as LLVM can help in applying software protection capabilities oriented towards or originally written for C/C++ source code structures and similar, to the protection of items of software provided in other source code representations, binary code representations and similar.

FIG. 15 therefore shows that an item of software for input to the optimization and protection toolset A40 can be in C/C++ source code (representation Rc), another source code (representation Rs) or a native/binary code (representation Rb). If the input item of software is in a C/C++ source code representation, then it can be converted to the second intermediate representation which is used by the protection component A112 using the X3 converter. All of the different representations of the input item of software can be converted to the first intermediate representation which is the LLVM IR using LLVM front end / binary tools A320,A330.

The input item of software can then be processed in various ways by elements of the unified toolset grouping A400. These components include the protection component A110 which operates on the item of software in the second intermediate representation, the binary rewriting protection component A135 which operates on the item of software in the LLVM intermediate representation, and the optimizer component A102 which operates on the item of software in the LLVM intermediate representation. The unified toolset grouping A400 also includes at least the first and second X1, X2 converters A122, A120 which convert between the LLVM intermediate representation and the second intermediate representation, so that any of the components of the unified toolset grouping A400 can act on the item of software A12.

After processing by the components of the unified toolset grouping A400, the item of software can be passed to various components for further processing in order to form the item of software in the relevant output representation. If passed from the unified toolset grouping A400 in the second intermediate representation the item of software can be converted back to the C/C++ source code representation Rc using converter X4 A126 for compiling and linking by C/C++ compiler and linker component A140-1. If passed from the unified toolset grouping A400 in the LLVM intermediate representation the item of software can be compiled and linked by the LLVM compiler and linker A140-2. In both cases the output from the optimization and protection toolset A40 is then the item of software in a native/binary code representation Rb. Alternatively, the item of software can be passed from the unified toolset grouping A400 in the LLVM intermediate representation to the converter X8 provided by the Emscripten tool A360 so that the output from the optimization and protection toolset A40 is then the item of software in the asm.js representation Ra.

Using the optimization and protection toolset A40 of FIG. 15, an item of software such as an application or software module or library, no matter what language has been used to implement it, can be protected using the same protection component A110 and the toolset of cloaking and other techniques which may be implemented by that component A110. If the item of software is output from the optimization and protection toolset A40 in native/binary code, this can be run in native execution environments (including PNaCl), or if output in JavaScript or asm.js, this can be run in web browser environments. This is achieved in the optimization and protection toolset A40 of FIG. 15 by operating the components of the unified toolset grouping A400 in two different intermediate representations, with the protection component A110 operating on the item of software in the second intermediate representation, and at least the optimizer component A100 operating on the item of software in the LLVM intermediate representation.

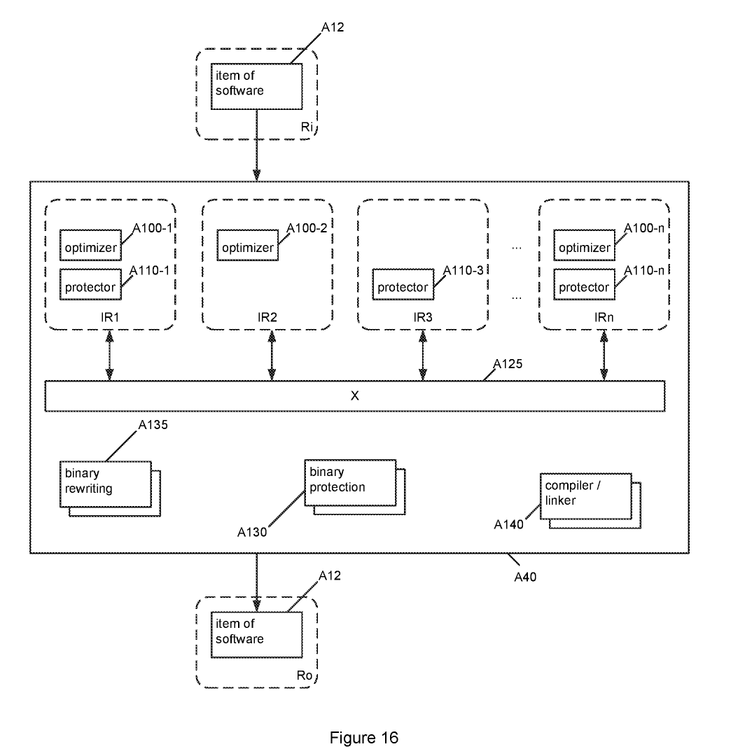

The arrangements illustrated in FIGS. 8-15 mostly make use of a first intermediate representation for carrying out optimization of an item of software, and a second intermediate representation for carrying out protection of the item of software. However, referring to FIG. 16, it is possible to use the first representation for carrying out protection of the item of software, and/or the second representation for carrying out optimization of the item of software. Additionally, although the arrangements of FIGS. 8-15 make use of two intermediate representations, it will be appreciated that it is possible to use of three of more intermediate representations, with each intermediate representation being used for one or both of optimization and protection of an item of software.

FIG. 16 is similar to FIG. 8, but shows how an arbitrary number of intermediate representations IR1 . . . IRN may be used by the optimization and protection toolset A40, with each intermediate representation being used for one or both of protection and optimization. For example, in the arrangement of FIG. 16 the first intermediate representation IR1 is used by both an optimizer component A100-1 and a protector component A110-1, the second intermediate representation is used by an optimizer component A100-2, but not by any protector component, and the third intermediate representation is used by a protector component A110-3 but not by any optimizer component. As for FIG. 8, each optimizer component may comprise one or more optimizer subcomponents (not shown in FIG. 16) and each protector component may comprise one or more protector subcomponents (also not shown in FIG. 16). These subcomponents may carry out any of the functions of optimization and protection as already discussed above, but within the confines of the appropriate intermediate representation.

Note that although FIG. 16 shows different protector and/or optimizer components for use with each different intermediate representation, it is also possible for one or more of the protector and/or optimizer components to work within multiple different ones of the intermediate representations. Although the components shown in FIG. 16 in respect of each intermediate representation are optimizer and/or protector components, components for carrying out other tasks and transformations on the item of software may be provided, for use in one or more of the intermediate representations.

The various intermediate representations IR1 . . . IRN may include LLVM IR, and various other representations for example as already discussed above. In order to convert the item of software, typically in various states of protection and/or optimization as the toolset is used, between the various intermediate representations IR1 . . . IRN, appropriate converter functionality A125 is provided. Converter functionality A125 may be implemented for example as a single library, class, tool or other element, or as multiple such elements with each such element carrying out one or more of the required conversion types. It is not always necessary for all possible conversions between the various intermediate representations to be provided, and similarly some conversions may be provided as combinations of two or more other conversions, for example through a more commonly used intermediate representation such as LLVM IR.

Also shown in FIG. 16 as part of the optimization and protection toolset A40 are one or more binary rewriting tools A135, one or more binary protection tools A130, and one or more compiler and/or linker tools A140. Each of these may operate using one or more of the intermediate representations IR1 . . . IRN, or other representations, according to the requirements of the toolset A40.

The optimization and protection toolset A40 discussed above and illustrated in FIGS. 8, 15 and 16 can be used to protect software components such as libraries, modules and agents, as well as applications, and all such software components fall within the scope of the described items of software A12. This is illustrated in FIG. 18 in which various items of software which may be security libraries, modules, agents and similar are input to the optimization and protection toolset A40, which outputs these items of software in protected and optimized forms. Any such item of software may be output in a native/binary code representation Rb and/or an asm.js representation Ra according to requirements. The arrows A420 connecting one or more of the optimized and protected items of software in the asm.js representation with one or more of the optimized and protected items of software in the native/binary code representation, and each of these with an underlying system layer A430 and a further underlying hardware layer A440, represent that each of the asm.js, native and system layers can access and use features such as security features of each lower level in the hierarchy.

In general, software components such as security libraries, modules and agents have their own security capabilities and features, and robustness and security of these software components may be critical in ensuring the security of applications within which they are used or by which they are referenced or called. The optimization and protection toolset A40 and work flows described herein can therefore be used to improve the security of such software components, and therefore also applications within which such components are used.

Using aspects of the described arrangements, a user device A20 can be provided with multiple layers of security including hardware level security features, system or operating system level security features, native layer security features and web layer security features. Software components such as libraries, modules and agents protected using the optimization and protection toolset A40 can provide access to hardware and system level security features which should not be made visible to the web application layer. Since the optimization and protection toolset A40 can be used to create protected software components in both native code and JavaScript (including asm.js), it can be used to construct and support invoking dependencies from protected software components in JavaScript / asm.js to protected software components in native code.

1. A method comprising:
providing a protected item of software to a device, wherein the protected item of software is in a scripted language or an interpreted language or source code, wherein the protected item of software, when executed by the device, is arranged to perform a security-related operation for the device, wherein the security-related operation is implemented, at least in part, by at least one protected portion of code in the protected item of software, wherein the at least one protected portion of code is arranged so that (a) the at least one protected portion of code has resistance against a white-box attack and/or (b) the at least one protected portion of code may only be executed on one or more predetermined devices.

2. The method of claim 1, comprising:
obtaining an initial item of software, wherein the security-related operation is implemented, at least in part, by at least one initial portion of code in the initial item of software;
generating the protected item of software, said generating comprising modifying at least the at least one initial portion of code to form the at least one protected portion of code.

3. The method of claim 2, wherein said modifying comprises applying one or more white-box protection techniques to the at least one initial portion of code.

4. The method of claim 2 or 3, wherein said modifying comprises applying one or more node-locking techniques to the at least one initial portion of code.

5. A method comprising:
obtaining at a device a protected item of software, wherein the protected item of software is in a scripted language or an interpreted language or source code, wherein the protected item of software, when executed by the device, is arranged to perform a security-related operation for the device, wherein the security-related operation is implemented, at least in part, by at least one protected portion of code in the protected item of software, wherein the at least one protected portion of code is arranged so that (a) the at least one protected portion of code has resistance against a white-box attack and/or (b) the at least one protected portion of code may only be executed on one or more predetermined devices; and
executing, on the device, the at least one protected portion of code of the obtained protected item of software.

6. The method of any one of the preceding claims, wherein the security-related operation uses secret data and wherein the at least one protected portion of code is in an obfuscated form to thereby protect the secret data against the white-box attack.

7. The method of any one of the preceding claims, wherein the security-related operation comprises one or more of:
(i) a cryptographic operation;
(ii) a conditional access operation;
(iii) a digital rights management operation;
(iv) concealing the destination of a communication;
(v) a key management operation;
(vi) a communication operation to establish a link to a server without using a lower level security sensitive primitive.

8. The method of claim 7, wherein the cryptographic operation comprises one or more of: an encryption operation; a decryption operation; a digital signature generation operation; a digital signature verification operation.

9. The method of any one of the preceding claims, wherein the language is one or more of:
(i) JavaScript;
(ii)
(iii) Python;
(iv) asm.js;
(v) Ruby.

10. The method of any one of the preceding claims, wherein the protected item of software is for execution in a browser on the device.

11. The method of any one of the preceding claims, wherein the protected item of software is a web app.

12. An apparatus arranged to carry out a method according to any one of claims 1 to 11.

13. A computer program which, when executed by a processor, causes the processor to carry out a method according to any one of claims 1 to 11.

14. A computer-readable medium storing a computer program according to claim 13.

15. A protected item of software for execution by a device, wherein the protected item of software is in a scripted language or an interpreted language or source code, when executed by the device, is arranged to perform a security-related operation for the device, wherein the security-related operation is implemented, at least in part, by at least one protected portion of code in the protected item of software, wherein the at least one protected portion of code is arranged so that (a) the at least one protected portion of code has resistance against a white-box attack and/or (b) the at least one protected portion of code may only be executed on one or more predetermined devices.

16. The protected item of software of claim 15, wherein the security-related operation uses secret data and wherein the at least one protected portion of code is in an obfuscated form to thereby protect the secret data against the white-box attack.

17. The protected item of software of claim 15 or 16, wherein the security-related operation comprises one or more of:
(i) a cryptographic operation;
(ii) a conditional access operation;
(iii) a digital rights management operation;
(iv) concealing the destination of a communication;
(v) a key management operation;
(vi) a communication operation to establish a link to a server without using a lower level security sensitive primitive.

18. The protected item of software of claim 17, wherein the cryptographic operation comprises one or more of: an encryption operation; a decryption operation; a digital signature generation operation; a digital signature verification operation.

19. The protected item of software of any one of claims 15 to 18, wherein the language is one or more of:
(i) JavaScript;
(ii) PHP;
(iii) Python;
(iv) asm.js;
(v) Ruby.

20. The protected item of software of any one of claims 15 to 19, wherein the protected item of software is for execution in a browser on the device.

21. The protected item of software of any one of claims 15 to 20, wherein the protected item of software is a web app.
